(19) United States
(12) Patent Application Publication
(10) Pub. No.: US 2025/0106018 A1
(43) Pub. Date: Mar. 27, 2025

(54) SECURITY FOR TRAFFIC RELAYING BY A WIRELESS COMMUNICATION DEVICE

(71) Applicant: TELEFONAKTIEBOLAGET LM ERICSSON (PUBL), STOCKHOLM (SE)

(72) Inventors: Monica Wifvesson, LUND (SE); Cheng Wang, SHANGHAI (CN)

(21) Appl. No.: 18/730,992

(22) PCT Filed: Nov. 16, 2022
(86) PCT No.: PCT/EP2022/082100

§ 371 Date: Jul. 22, 2024

(30) Foreign Application Priority Data
Jan. 21, 2022 (WO) PCT/CN2022/073223

(51) Int. Cl. H04L 9/08; H04W 88/04

(52) U.S. Cl. CPC H04L 9/088; H04W 88/04

(57) ABSTRACT

A method performed by an authentication server is provided. The method comprises receiving a request for authentication of a remote wireless communication device, wherein the request requests reuse of a proximity services relay user key for deriving a shared key for protecting an interface between the remote wireless communication device and a relay wireless communication device, wherein the relay wireless communication device is configured to relay traffic for the remote wireless communication device.

### TECHNICAL FIELD

The present application relates generally to relaying of traffic by a wireless communication device, and relates more specifically to security for such traffic relaying.

### BACKGROUND

Proximity services (ProSe) in a wireless communication network enable wireless communication devices that are in proximity of one another to communicate directly, via a path not traversing any network node. Proximity services relaying exploits ProSe so that one wireless communication device can relay traffic for another wireless communication device in proximity. For example, a so-called ProSe device-to-network relay is a wireless communication device that relays unicast traffic between a remote wireless communication device and the wireless communication network. Via a Pro-Se device-to-network relay, then, the remote wireless communication device can communicate with the network even if the remote wireless communication device is outside of the network's coverage.

The interface between the remote wireless communication device and the relay wireless communication device can be protected based on a ProSe relay user key (PRUK), e.g., referred to as a 5GPRUK in a 5G network. Generating a new ProSe relay user key each time the remote wireless communication device establishes an interface with a relay wireless communication device would protect the interface well, as compromise of the ProSe relay user key would be limited to only one session of the interface. However, generating a new ProSe relay user key would inefficiently require re-running primary authentication of the remote wireless communication device. Re-using the ProSe relay user key across different sessions of the interface would therefore prove more efficient. Challenges exist, though, in reusing the ProSe relay user key, at least in a way that comports with existing design principles for the wireless communication network. For example, the approach described in 3GPP TS 33.503 v0.2.0 for securing 5G ProSe communication via a 5G ProSe Layer-3 UE-to-Network Relay over the control plane would unconventionally impose a burden on the authentication server (AUSF) to manage a PRUK ID for the PRUK, rather than just having to manage the remote wireless communication device's subscription ID as is conventional.

### SUMMARY

Some embodiments herein introduce a new node, referred to as a proximity services anchor node, to support reuse of a proximity services relay user key in a wireless communication network. The proximity services anchor node in this regard may store a proximity services relay user key for a remote wireless communication device and bind an identifier to that key, so that the key can be retrieved later (for reuse) based on that identifier. With reuse of the proximity services relay user key supported by the proximity services anchor node in this way, the proximity services anchor node effectively insulates other nodes in the communication network from the details of proximity services relay user key reuse. The authentication server, for instance, would be insulated from having to manage the identifier bound to the proximity services relay user key and would therefore simply be able to manage the remote wireless communication device's subscription ID as conventional.

Other embodiments herein introduce proximity services reuse signaling for requesting reuse of a proximity services relay user key. Such signaling may for instance simply request reuse of the proximity services relay user key, e.g., whatever proximity services relay user key was used last, without specifying an identity bound to that last used key. These embodiments thereby effectively free nodes in the wireless communication network from the burden of having to manage identifiers bound to proximity services relay user keys.

No matter whether via a proximity services anchor node or via proximity services reuse signaling, some embodiments herein advantageously enable reuse of the proximity services relay user key in a way that comports with existing design principles for the wireless communication network, e.g., whereby an authentication server still needs only rely on the remote wireless communication device's subscription ID.

More particularly, embodiments herein include a method performed by a remote wireless communication device. The method comprises transmitting, to a relay wireless communication device, a request for the relay wireless communication device to relay traffic for the remote wireless communication. In this case, the request requests reuse of a proximity services relay user key already associated with the remote wireless communication device.

In some embodiments, the request requests reuse of a proximity services relay user key from a previous run of a primary authentication procedure for primary authentication of the remote wireless communication device.

In some embodiments, the request includes a proximity services relay user key reuse flag that requests reuse of a proximity services relay user key already associated with the remote wireless communication device.

In some embodiments, the proximity services relay user key is based on and/or is specific to a certain run of a primary authentication procedure for primary authentication of the remote wireless communication device.

In some embodiments, the method further comprises receiving, from the relay wireless communication device, a response to the request indicating that the proximity services relay user key is to be reused.

In some embodiments, the method further comprises reusing the proximity services relay user key to generate a shared key for protecting an interface between the remote wireless communication device and the relay wireless communication device, and protecting the interface using the shared key. In one or more of these embodiments, the shared key is a key K_{NR_ProSe}. In one or more of these embodiments, the interface is a PC5 interface.

In some embodiments, the proximity services relay user key is a 5G Proximity Services Relay User Key, 5GPRUK.

In some embodiments, the relay wireless communication device is a Layer-3 UE-to-Network Relay.

Other embodiments herein include a method performed by a relay wireless communication device. The method comprises receiving, from a remote wireless communication device, a request for the relay wireless communication device to relay traffic for the remote wireless communication. In this case, the request requests reuse of a proximity services relay user key already associated with the remote wireless communication device.

In some embodiments, the request requests reuse of a proximity services relay user key from a previous run of a primary authentication procedure for primary authentication of the remote wireless communication device.

In some embodiments, the request includes a proximity services relay user key reuse flag that requests reuse of a proximity services relay user key already associated with the remote wireless communication device.

In some embodiments, the proximity services relay user key is based on and/or is specific to a certain run of a primary authentication procedure for primary authentication of the remote wireless communication device.

In some embodiments, the method further comprises transmitting, to the remote wireless communication device, a response to the request indicating that the proximity services relay user key is to be reused.

In some embodiments, the proximity services relay user key is a 5G Proximity Services Relay User Key, 5GPRUK.

In some embodiments, the relay wireless communication device is a Layer-3 UE-to-Network Relay.

In some embodiments, the method further comprises transmitting, to a network node serving the relay wireless communication device, a request for a shared key for protecting an interface between the remote wireless communication device and the relay wireless communication device. In this case, the request for the shared key requests reuse of the proximity services relay user key for deriving the shared key. In one or more of these embodiments, the request for the shared key includes a proximity services relay user key reuse flag that requests reuse of the proximity services relay user key. In one or more of these embodiments, the method further comprises receiving, from the network node, a response to the request for the shared key. In this case, the response to the request for the shared key includes the shared key and indicates that the proximity services relay user key is to be reused for deriving the shared key.

Other embodiments herein include a method performed by a relay wireless communication device. The method comprises transmitting, to a network node serving the relay wireless communication device, a request for a shared key for protecting an interface between a remote wireless communication device and the relay wireless communication device. In this case, the relay wireless communication device is configured to relay traffic for the remote wireless communication device, and the request for the shared key requests reuse of a proximity services relay user key for deriving the shared key.

In some embodiments, the request for the shared key includes a proximity services relay user key reuse flag that requests reuse of the proximity services relay user key.

In some embodiments, the method further comprises receiving, from the network node, a response to the request for the shared key. In this case, the response to the request for the shared key includes the shared key and indicates that the proximity services relay user key is to be reused for deriving the shared key.

In some embodiments, the request requests reuse of a proximity services relay user key from a previous run of a primary authentication procedure for primary authentication of the remote wireless communication device.

In some embodiments, the proximity services relay user key is based on and/or is specific to a certain run of a primary authentication procedure for primary authentication of the remote wireless communication device.

In some embodiments, the method further comprises receiving, from the remote wireless communication device, a request for the relay wireless communication device to relay traffic for the remote wireless communication. In this case, the request requests reuse of a proximity services relay user key already associated with the remote wireless communication device. The method further comprises transmitting, to the remote wireless communication device, a response to the request. In this case, the response includes the shared key and indicates that the proximity services relay user key is to be reused for deriving the shared key.

In some embodiments, the proximity services relay user key is a 5G Proximity Services Relay User Key, 5GPRUK.

In some embodiments, the relay wireless communication device is a Layer-3 UE-to-Network Relay.

In some embodiments, the shared key is a key K_{NR_ProSe}.

In some embodiments, the network node implements an Access and Mobility Function, AMF.

In some embodiments, the interface is a PC5 interface.

Other embodiments herein include a method performed by a network node serving a relay wireless communication device. The method comprises receiving, from the relay wireless communication device, a request for a shared key for protecting an interface between a remote wireless communication device and the relay wireless communication device. In this case, the relay wireless communication device is configured to relay traffic for the remote wireless communication device, and the request requests reuse of a proximity services relay user key for deriving the shared key.

In some embodiments, the request requests reuse of a proximity services relay user key from a previous run of a primary authentication procedure for primary authentication of the remote wireless communication device.

In some embodiments, the request includes a proximity services relay user key reuse flag that requests reuse of a proximity services relay user key already associated with the remote wireless communication device.

In some embodiments, the proximity services relay user key is based on and/or is specific to a certain run of a primary authentication procedure for primary authentication of the remote wireless communication device.

In some embodiments, the method further comprises transmitting, to the relay wireless communication device, a response to the request. In this case, the response includes the shared key and indicates that the proximity services relay user key is to be reused for deriving the shared key.

In some embodiments, the proximity services relay user key is a 5G Proximity Services Relay User Key, 5GPRUK.

In some embodiments, the relay wireless communication device is a Layer-3 UE-to-Network Relay.

In some embodiments, the shared key is a key K_{NR_ProSe}.

In some embodiments, the network node implements an Access and Mobility Function, AMF.

In some embodiments, the interface is a PC5 interface.

Other embodiments herein include a method performed by a network node serving a relay wireless communication device. The method comprises transmitting, to an authentication server, a request for authentication of the remote wireless communication device. In this case, the request requests reuse of a proximity services relay user key for deriving a shared key for protecting an interface between the remote wireless communication device and the relay wireless communication device, and the relay wireless communication device is configured to relay traffic for the remote wireless communication device.

In some embodiments, the request requests reuse of a proximity services relay user key from a previous run of a primary authentication procedure for primary authentication of the remote wireless communication device.

In some embodiments, the request includes a proximity services relay user key reuse flag that requests reuse of a proximity services relay user key already associated with the remote wireless communication device.

In some embodiments, the proximity services relay user key is based on and/or is specific to a certain run of a primary authentication procedure for primary authentication of the remote wireless communication device.

In some embodiments, the method further comprises receiving, from the authentication server, a response to the request. In this case, the response includes the shared key and indicates that the proximity services relay user key is to be reused for deriving the shared key. In some embodiments, the proximity services relay user key is a 5G Proximity Services Relay User Key, 5GPRUK.

In some embodiments, the relay wireless communication device is a Layer-3 UE-to-Network Relay.

In some embodiments, the shared key is a key K_{NR_ProSe}.

In some embodiments, the network node implements an Access and Mobility Function, AMF.

In some embodiments, the interface is a PC5 interface.

Other embodiments herein include a method performed by an authentication server. The method comprises receiving a request for authentication of a remote wireless communication device. In this case, the request requests reuse of a proximity services relay user key for deriving a shared key for protecting an interface between the remote wireless communication device and a relay wireless communication device, where the relay wireless communication device is configured to relay traffic for the remote wireless communication device.

In some embodiments, the request requests reuse of a proximity services relay user key from a previous run of a primary authentication procedure for primary authentication of the remote wireless communication device.

In some embodiments, the request includes a proximity services relay user key reuse flag that requests reuse of a proximity services relay user key already associated with the remote wireless communication device.

In some embodiments, the proximity services relay user key is based on and/or is specific to a certain run of a primary authentication procedure for primary authentication of the remote wireless communication device.

In some embodiments, the method further comprises transmitting a response to the request. In this case, the response includes the shared key and indicates that the proximity services relay user key is to be reused for deriving the shared key

In some embodiments, the proximity services relay user key is a 5G Proximity Services Relay User Key, 5GPRUK.

In some embodiments, the relay wireless communication device is a Layer-3 UE-to-Network Relay.

In some embodiments, the shared key is a key K_{NR_ProSe}.

In some embodiments, the request is received from an Access and Mobility Function, AMF.

In some embodiments, the interface is a PC5 interface.

In some embodiments, the method further comprises transmitting, to a data management node, a request for authentication credentials for the remote wireless communication device. In this case, the request for authentication credentials requests reuse of the proximity services relay user key. In one or more of these embodiments, the method further comprises receiving a response to the request for authentication credentials from the data management node. In this case, the response indicates whether the proximity services relay user key is available for reuse. In one or more of these embodiments, the response indicates that the proximity services relay user key is available for reuse. In this case, the method further comprises obtaining the shared key as derived from the proximity services relay user key, and transmitting a response to the request for authentication. In this case, the response to the request for authentication includes the obtained shared key and indicates that the proximity services relay user key is to be reused for deriving the shared key. In one or more of these embodiments, obtaining the shared key comprises retrieving the proximity services relay user key from local storage at the authentication server and deriving the shared key from the retrieved proximity services relay user key. In one or more of these embodiments, obtaining the shared key comprises forwarding the request for authentication to another authentication server at which the proximity services relay user key is stored, and receiving, from the another authentication server, the shared key as derived from the proximity services relay user key. In one or more of these embodiments, the response indicates that the proximity services relay user key is not available for reuse and includes the requested authentication credentials. In this case, the method further comprises generating a proximity services relay user key based on key material derived during authentication of the remote wireless communication device, wherein the authentication of the remote wireless communication device is based on the authentication credentials, deriving the shared key from the generated proximity services relay user key, and transmitting a response to the request for authentication. In this case, the response to the request for authentication includes the derived shared key. In one or more of these embodiments, the response to the request for authentication indicates that the proximity services relay user key is not to be reused for deriving the shared key. Alternatively or additionally, the method may further comprise, after generating the proximity services relay user key, transmitting, to the data management node, signaling indicating that a proximity services relay user key for the remote wireless communication device is available for reuse and indicating the identity of the authentication server at which the proximity services relay user key is stored.

Other embodiments herein include a method performed by an authentication server. The method comprises transmitting, to a data management node, a request for authentication credentials for a remote wireless communication device. In this case, the request for authentication credentials requests reuse of a proximity services relay user key for deriving a shared key for protecting an interface between the remote wireless communication device and a relay wireless communication device configured to relay traffic for the remote wireless communication device.

In some embodiments, the request is received from a network node serving the relay wireless communication device. In other embodiments, the request is received from another authentication server.

In some embodiments, the method further comprises receiving a response to the request for authentication credentials from the data management node. In this case, the response indicates whether the proximity services relay user key is available for reuse. In one or more of these embodiments, the response indicates that the proximity services relay user key is available for reuse. In this case, the method further comprises obtaining the shared key as derived from the proximity services relay user key, and transmitting, to a network node, a response to a request for authentication. In this case, the response to the request for authentication includes the obtained shared key and indicates that the proximity services relay user key is to be reused for deriving the shared key. In one or more of these embodiments, obtaining the shared key comprises retrieving the proximity services relay user key from local storage at the authentication server and deriving the shared key from the retrieved proximity services relay user key. In one or more of these embodiments, obtaining the shared key comprises forwarding the request for authentication to another authentication server at which the proximity services relay user key is stored, and receiving, from the another authentication server, the shared key as derived from the proximity services relay user key.

In some embodiments, the response indicates that the proximity services relay user key is not available for reuse and includes the requested authentication credentials. In this case, the method further comprises generating a proximity services relay user key based on key material derived during authentication of the remote wireless communication device. In this case, the authentication of the remote wireless communication device is based on the authentication credentials. The method further comprises deriving the shared key from the generated proximity services relay user key, and transmitting, to a network node, a response to a request for authentication. In this case, the response to the request for authentication includes the derived shared key. In one or more of these embodiments, the response to the request for authentication indicates that the proximity services relay user key is not to be reused for deriving the shared key.

In some embodiments, the proximity services relay user key is a 5G Proximity Services Relay User Key, 5GPRUK.

In some embodiments, the relay wireless communication device is a Layer-3 UE-to-Network Relay.

In some embodiments, the shared key is a key K_{NR_ProSe}.

In some embodiments, the network node implements an Access and Mobility Function, AMF.

In some embodiments, the interface is a PC5 interface.

Other embodiments herein include a method performed by a data management node. The method comprises receiving, from an authentication server, a request for authentication credentials for a remote wireless communication device. In this case, the request for authentication credentials requests reuse of a proximity services relay user key for deriving a shared key that is to protect an interface between the remote wireless communication device and a relay wireless communication device configured to relay traffic for the remote wireless communication device.

In some embodiments, the method further comprises transmitting, to the authentication server, a response to the request. In this case, the response indicates whether the proximity services relay user key is available for reuse. In one or more of these embodiments, the response indicates that the proximity services relay user key is available for reuse. In one or more of these embodiments, the response indicates an identity of an authentication server at which the proximity services relay user key is stored. In one or more of these embodiments, the response indicates that the proximity services relay user key is not available for reuse and includes the requested authentication credentials. In one or more of these embodiments, the method further comprises, after transmitting the response, receiving signaling indicating an identity of an authentication server at which a proximity services relay user key is stored, and storing information at the data management node indicating that a proximity services relay user key for the remote wireless communication device is available for reuse and indicating the identity of the authentication server at which the proximity services relay user key is stored.

In some embodiments, the method further comprises checking whether the proximity services relay user key is available for reuse, based on information at the data management node indicating whether any proximity services relay user key is stored for the remote wireless communication device.

In some embodiments, the proximity services relay user key is a 5G Proximity Services Relay User Key, 5GPRUK.

In some embodiments, the relay wireless communication device is a Layer-3 UE-to-Network Relay.

In some embodiments, the shared key is a key K_{NR_ProSe}.

In some embodiments, the interface is a PC5 interface.

Of course, the present disclosure is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of proximity services relay user key reuse according to some embodiments.

FIG. 2 is a block diagram of a key hierarchy according to some embodiments.

FIGS. 3A-3B are call flow diagrams for proximity services relay user key reuse according to some embodiments.

FIGS. 4A-4B are call flow diagrams for proximity services relay user key reuse according to other embodiments.

FIGS. 5A-5B are call flow diagrams for proximity services relay user key reuse according to still other embodiments.

FIGS. 6A-6B are call flow diagrams for proximity services relay user key reuse according to yet other embodiments.

FIG. 7 is a block diagram of proximity services relay user key reuse according to other embodiments.

FIGS. 8A-8B are call flow diagrams for proximity services relay user key reuse according to some embodiments.

FIG. 9 is a logic flow diagram of a method performed by a proximity services anchor node according to some embodiments.

FIG. 10 is a logic flow diagram of a method performed by an authentication server according to some embodiments.

FIG. 11 is a logic flow diagram of a method performed by a network node according to some embodiments.

FIG. 12 is a logic flow diagram of a method performed by a remote wireless communication device according to some embodiments.

FIG. 13 is a logic flow diagram of a method performed by a relay wireless communication device according to some embodiments.

FIG. 14 is a logic flow diagram of a method performed by a relay wireless communication device according to some embodiments.

FIG. 15 is a logic flow diagram of a method performed by a network node according to some embodiments.

FIG. 16 is a logic flow diagram of a method performed by a network node according to some embodiments.

FIG. 17 is a logic flow diagram of a method performed by an authentication server according to some embodiments.

FIG. 18 is a logic flow diagram of a method performed by an authentication server according to some embodiments.

FIG. 19 is a logic flow diagram of a method performed by a data management node according to some embodiments.

FIG. 20 is a block diagram of a wireless communication device according to some embodiments.

FIG. 21 is a block diagram of a proximity services anchor node according to some embodiments.

FIG. 22 is a block diagram of an authentication server according to some embodiments.

FIG. 23 is a block diagram of a network node according to some embodiments.

FIG. 24 is a block diagram of a data management node according to some embodiments.

FIG. 25 is a block diagram of a communication system in accordance with some embodiments FIG. 26 is a block diagram of a user equipment according to some embodiments.

FIG. 27 is a block diagram of a network node according to some embodiments.

FIG. 28 is a block diagram of a host according to some embodiments.

FIG. 29 is a block diagram of a virtualization environment according to some embodiments.

FIG. 30 is a block diagram of a host communicating via a network node with a UE over a partially wireless connection in accordance with some embodiments.

### DETAILED DESCRIPTION

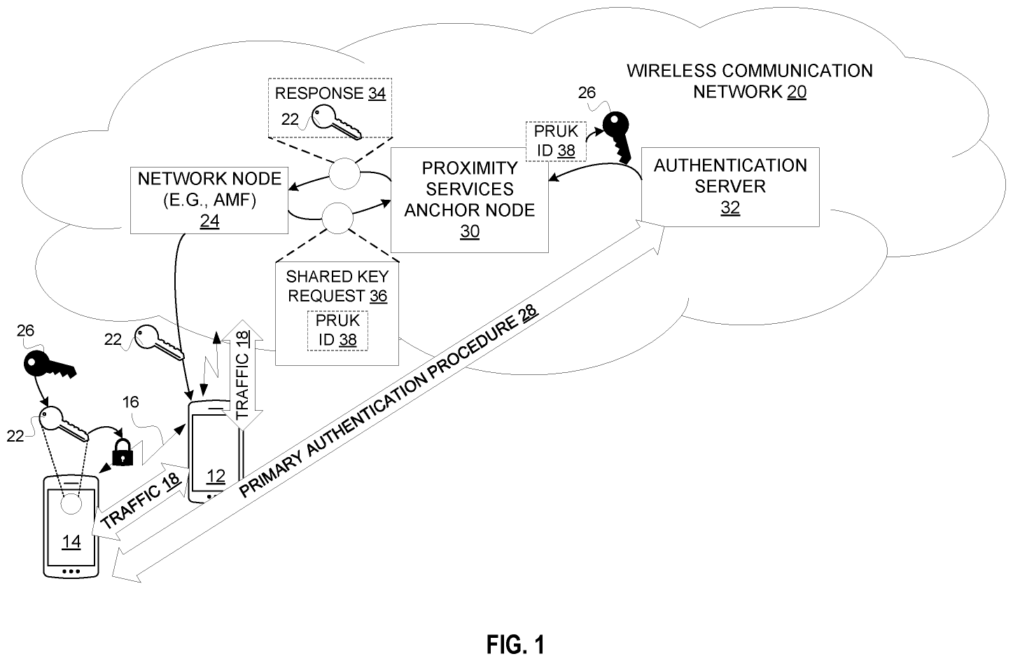

FIG. 1 shows proximity services (ProSe) relaying according to some embodiments. As shown, wireless communication devices 12, 14 are in proximity of one another and communicate directly over an interface 16, e.g., a PC5 interface as defined according to 3GPP standards. Communicating directly over interface 16, wireless communication devices 12, 14 communicate via a path that does not traverse any network node. The wireless communication devices 12, 14 exploit this proximity services direct communication in such a way that wireless communication device 12 can relay traffic 18 for wireless communication device 14, e.g., at layer 2 or layer 3 of the devices' protocol stack. Wireless communication device 12 is accordingly referred to as a relay wireless communication device 12 whereas wireless communication device 14 is referred to as a remote wireless communication device 14. In one embodiment as shown, for instance, the relay wireless communication device 12 relays traffic 18 between the remote wireless communication device 14 and a wireless communication network 20. Via the relay wireless communication device 12, then, the remote wireless communication device 14 can communicate with the network 20 even if the remote wireless communication device 14 is outside of (i.e., remote to) the network's coverage.

The interface 16 between the wireless communication devices 12, 14 is protected based on a shared key 22, i.e., shared between the wireless communication devices 12, 14. The shared key 22 may for instance be a root key from which cryptographic keys for confidentiality protection and/or integrity protection of the interface 16 are directly or indirectly derived. In some embodiments, the shared key 22 is shared between the wireless communication devices 12, 14 in the sense that the shared key 22 is established at both wireless communication devices 12, 14. For example, in one embodiment, the remote wireless communication device 14 generates the shared key 22 itself, whereas the relay wireless communication device 12 receives the same shared key 22 from a network node 24 in the wireless communication network 20, e.g., implementing an access and mobility function (AMF). With the shared key 22 established at both wireless communication devices 12, 14 in this way, each wireless communication device 12, 14 can use the shared key 22 to derive cryptographic keys (not shown) for confidentially protection and/or integrity protection of the interface 16. The wireless communication devices 12, 14 may then communicate securely over the interface 16 by applying confidentiality protection using a confidentiality key and/or by applying integrity protection using an integrity key.

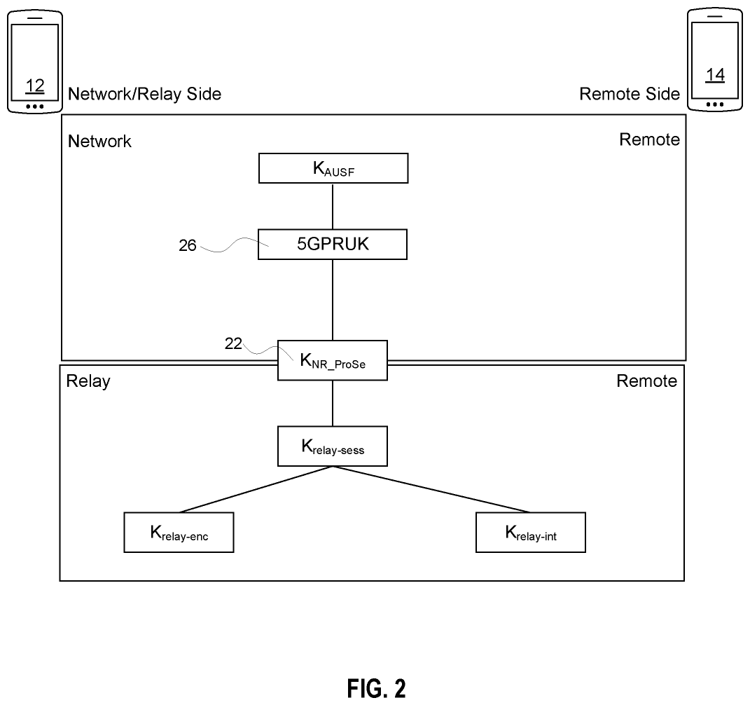

In embodiments herein, the shared key 22 is in turn derived from a proximity services relay user key 26, also referred to as a PRUK key 26, where PRUK stands for ProSe Relay User Key. FIG. 2 shows one example implementation of the proximity services relay user key 26 in embodiments where the wireless communication network 20 is a 5G network. As shown, an intermediate key K_{AUSF} is established at the remote wireless communication device 14 and at the wireless communication network 10. A key 5GPRUK is derived from this intermediate key K_{AUSF}, where the 5GPRUK exemplifies the proximity services relay user key 26. In one embodiment, the 5GPRUK is the root credential derived from K_{AUSF} that is the root of security of a PC5 unicast link between the wireless communication devices 12, 14. In turn, a key K_{NR_ProSe} is derived from the 5GPRUK, where the key K_{NR_ProSe} exemplifies the shared key 22. In one embodiment, the key K_{NR_ProSe} is a root key (e.g., a 256-bit root key) that is established between the wireless communication devices 12, 14 that communicate using a New Radio (NR) PC5 unicast link. This key K_{NR_ProSe} is established at both the remote wireless communication device 14 and the relay wireless communication device 12. Each of the wireless communication devices 12, 14 use the key K_{NR_ProSe} to derive keys that protect the transfer of data between the devices 12, 14 over the interface 16. In this regard, each of the wireless communication devices 12, 14 derive a key K_{relay-sess} from the key K_{NR_ProSe}, where the key K_{relay-sess} is derived per unicast link and/or each time a unicast communication session is activated between the devices 12, 14. Each of the wireless communication devices 12, 14 in turn derive a key K_{relay-int} and a key K_{relay-enc} that are to be respectively used in a chosen integrity algorithm and a chosen encryption algorithm for protecting PC5-S signaling, PC5 radio resource control (RRC) signaling, and PC5 user plane data.

No matter whether the wireless communication network 10 is a 5G network or not, though, generating a new proximity services relay user key 26 each time the remote wireless communication device 14 establishes an interface 16 with the same or a different relay wireless communication device would protect the interface 16 well, as compromise of the proximity services relay user key 26 would be limited to only one session of the interface 16. However, in some embodiments, the proximity services relay user key 26 is based on and/or is specific to a certain run of a primary authentication procedure 28 for primary authentication of the remote wireless communication device 14, e.g., to the wireless communication network 10. In these embodiments, then, generating a new proximity services relay user key 26 each time the remote wireless communication device 14 establishes an interface 16 with the same or a different relay wireless communication device would inefficiently require re-running the primary authentication procedure 28 each time.

Some embodiments herein accordingly facilitate re-using the proximity services relay user key 26, e.g., across different sessions of the interface 16. Moreover, some embodiments herein facilitate reuse of the proximity services relay user key 26 in a way that comports with existing design principles for the wireless communication network 10, e.g., whereby an authentication server still needs only rely on the remote wireless communication device's subscription ID.

Some embodiments in this regard introduce a new node, referred to as a proximity services anchor node 30, to support reuse of the proximity services relay user key 26. As shown, the proximity services anchor node 30 receives, from an authentication server 32, the proximity services relay user key 26 that is associated with the remote wireless communication device 14. The proximity services anchor node 30 derives the shared key 22 from this proximity services relay user key 26 and transmits the shared key 22 to the network node 24 serving the relay wireless communication device 12. The proximity services anchor node 30 may for example transmit the shared key 22 to the network node 24 in a response 34 to a shared key request 36 from the network node 24 requesting the shared key 22.

The proximity services anchor node 30 in some embodiments stores the proximity services relay user key 26, e.g., in storage at the proximity services anchor node 30, so that the key 26 can be retrieved later for reuse. With reuse of the proximity services relay user key 26 supported by the proximity services anchor node 30 in this way, the proximity services anchor node 30 effectively insulates other nodes in the wireless communication network 10 from the details of proximity services relay user key reuse. The authentication server 32, for instance, would be insulated from these details.

In one or more embodiments as shown, for example, the proximity services anchor node 30 also receives from the authentication server 32 an identifier 38 bound to the proximity services relay user key 26. The identifier 38 may for instance be referred to as a PRUK ID. After transmitting the identifier 38 to the proximity services anchor node 30, the authentication server 32 need not store or manage the identifier 38. Rather, the proximity services anchor node 30 stores the proximity services relay user key 26 in association with the identifier 38. The proximity services anchor node 30 may then later retrieve the proximity services relay user key 26 from storage using the identifier 38 bound to that key 26. This correspondingly enables the network node 24 to include the identifier 38 in its shared key request 36, as a way to request that the shared key 22 be derived from a reused proximity services relay user key bound to that identifier 38. These embodiments thereby enable reuse of the proximity service relay user key 26 in a way that frees the authentication server 32 from having to manage or store the identifier 38 bound to the proximity services relay user key 26, i.e., consistent with existing paradigms.

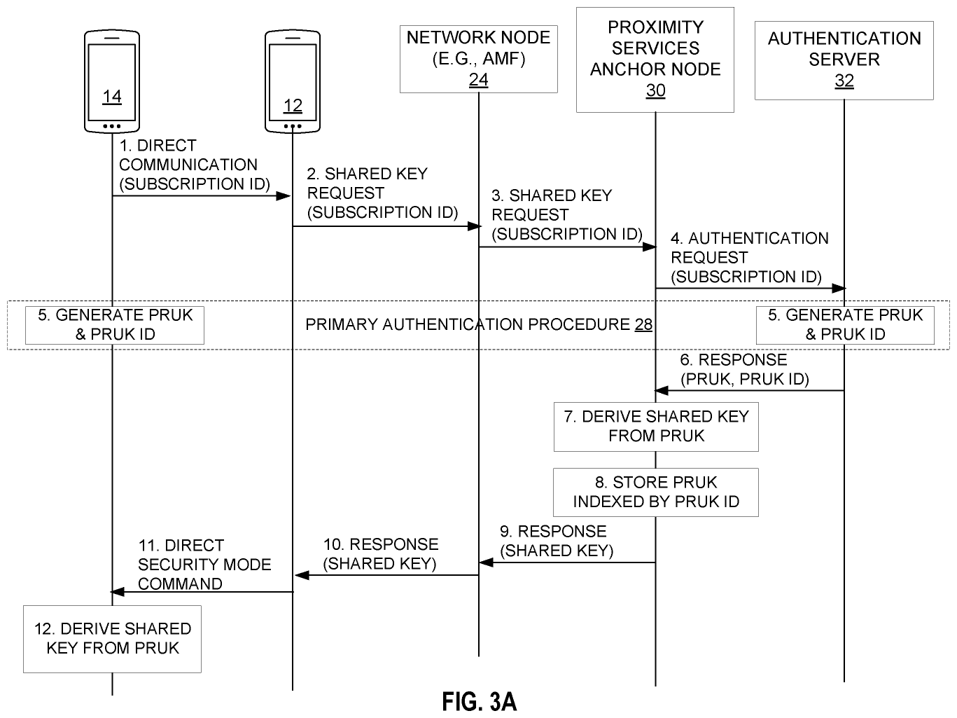

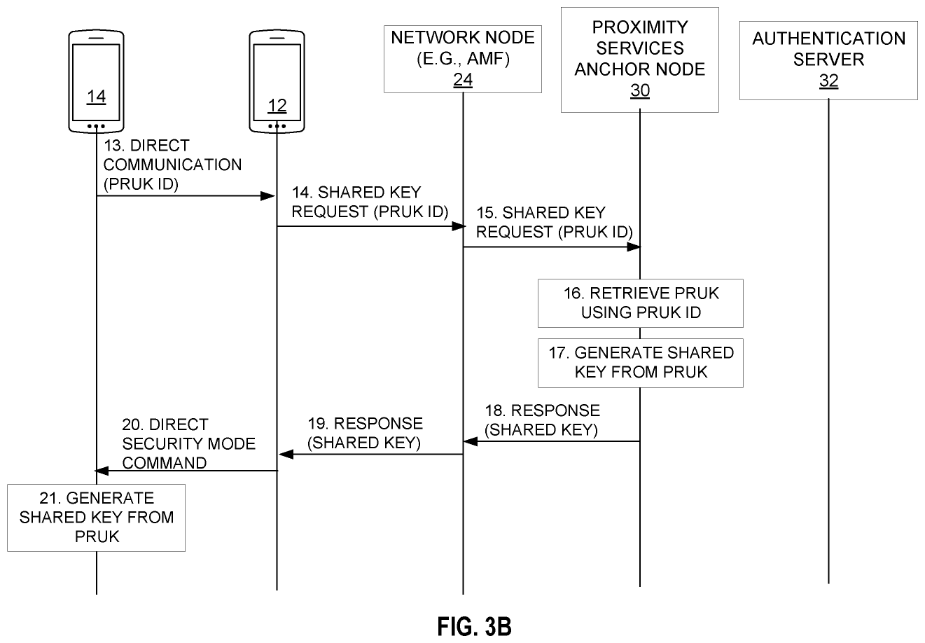

FIGS. 3A-3B show an example call flow according to some embodiments. As depicted in FIG. 3A, the remote wireless communication device 14 sends a direct communication request to the relay wireless communication device 12 for establishing a secure unicast link over the interface 16 (Step 1). This direct communication request includes a subscription identifier (ID) which identifies a subscription to the wireless communication network 20. In order to establish the secure unicast link over the interface 16, the relay wireless communication device 12 correspondingly sends a shared key request to the network node 24 (e.g., AMF), where the shared key request requests the shared key 22 for protecting the interface 16 and includes the subscription identifier (Step 2). The network node 24 in turns transmits a corresponding shared key request to the proximity services anchor node 30 (Step 3).

After the proximity services anchor node 30 receives the shared key request from the network node 24, the proximity services anchor node 30 transmits, to the authentication server 32, a request for primary authentication of the remote wireless communication device 14 (Step 4). This request may include the subscription identifier for the remote wireless communication device 14. Based on the request, the authentication server 32 triggers a run of the primary authentication procedure 28, during which the remote wireless communication device 14 and the authentication server generate the proximity services relay user key (PRUK) 26 as well as an identifier 38 (shown as PRUK ID) bound to that proximity services relay user key (PRUK) 26 (Step 5). After this, the authentication server 32 transmits, to the proximity services anchor node 30, a response to the request for primary authentication, where the response includes the proximity services relay user key 26 as well as the identifier 38 (Step 6). In some embodiments, although not shown, the response may also include the subscription identifier for the remote wireless communication device 14.

The proximity services anchor node 30 correspondingly receives the response from the authentication server 32, including the proximity services relay user key (PRUK) 26 and the identifier 38. Having obtained the proximity services relay user key (PRUK) 26, the proximity services anchor node 30 derives the shared key 22 from the PRUK 26 (Step 7). The proximity services anchor node 30 also stores the PRUK 26 in association with the identifier 38, e.g., such that the PRUK 26 is indexed by the identifier 38 (Step 8). The proximity services anchor node 30 transmits a response to the shared key request, where the response includes the shared key 22 (Step 9). The network node 24 receives the shared key 22 in the response and correspondingly transmits the shared key 22 to the relay wireless communication device 12, e.g., in a response to the shared key request from the relay wireless communication device 12 (Step 10).

The relay wireless communication device 12 as shown transmits a direct security mode command to the remote wireless communication device 14, e.g., including one or more other parameters such as a nonce from which the shared key 22 is derivable (Step 11). The remote wireless communication device 14 finally derives the shared key 22 from the PRUK 26 generated in step 5 (Step 12).

FIG. 3B shows the call flow diagram for reusing the PRUK 26 from FIG. 3A, e.g., for protecting subsequent establishment of an interface 16 between the remote wireless communication device 14 and the same or a different relay wireless communication device 12. As shown, the remote wireless communication device 14 transmits a direct communication request to the same or a different relay wireless communication device 12 (Step 13). This time, though, rather than including the subscription identifier for the remote wireless communication device 14, the direct communication request includes the identifier (PRUK ID) 38 bound to the PRUK 26. The relay wireless communication device 12 correspondingly transmits a shared key request to the network node 24 (Step 14). Since this is a subsequent shared key request, the shared key request effectively requests a fresh shared key that is different than the previous shared key used in FIG. 3A. Rather than including the subscription identifier, though, this fresh shared key request includes the identifier (PRUK ID) 38 bound to the PRUK 26. This means that the shared key request effectively requests that the PRUK 26 from FIG. 3A be re-used for deriving the fresh shared key. In any event, the network node 24 likewise transmits a corresponding shared key request to the proximity services anchor node 30 (Step 15).

The proximity services anchor node 30 receives the fresh shared key request. Using the identifier 38 indicated in the fresh shared key request, the proximity services anchor node 30 retrieves the PRUK 26 from storage at the proximity services anchor node 30 (Step 16). The proximity services anchor node 30 then re-uses the retrieved PRUK 26 to derive the fresh shared key 22 requested (Step 17). That is, rather than trigger primary authentication of the remote wireless communication device 14 via the authentication server 32, for generation of a new PRUK 26, the proximity services anchor node 30 re-uses the PRUK 26 generated from a previous run of the primary authentication procedure 28 in FIG. 3A. Moreover, with the PRUK 26 stored at the proximity services anchor node 30 and with reuse of the PRUK 26 accomplished by the proximity services anchor node 30, the authentication server 32 need not even be involved or impacted by reuse of the PRUK 26. In any event, the proximity services anchor node 30 then transmits the fresh shared key 22 to the network node 24 in response to the fresh shared key request (Step 18).

Similar to FIG. 3A, the network node 24 receives the shared key 22 in the response and correspondingly transmits the shared key 22 to the relay wireless communication device 12, e.g., in a response to the shared key request from the relay wireless communication device 12 (Step 19). The relay wireless communication device 12 again transmits a direct security mode command to the remote wireless communication device 14 (Step 20), and the remote wireless communication device 14 derives the shared key 22 from the re-used PRUK 26 that was generated in step 5 (Step 21).

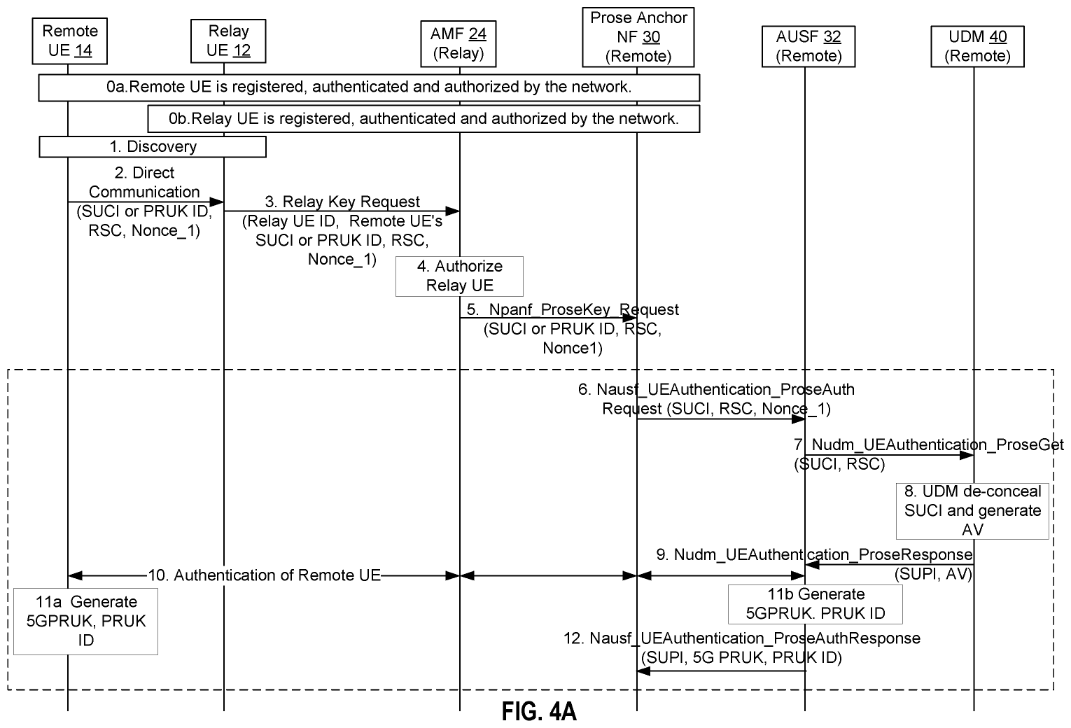

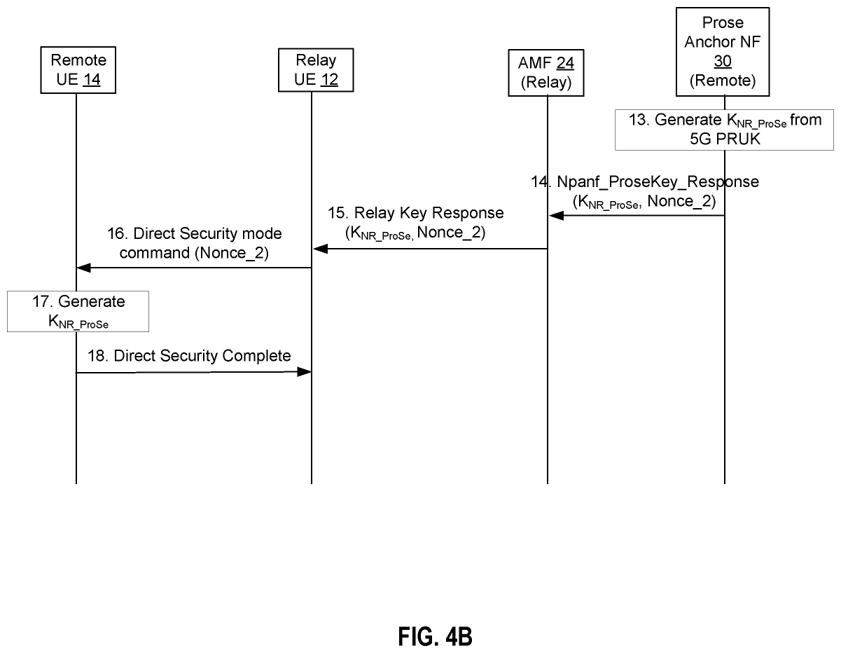

FIGS. 4A-4B illustrate a more detailed example of the embodiments from FIGS. 3A-3B, in the context where the wireless communication network 20 is a 5G network. In this example, the remote wireless communication device 14 is exemplified as a remote user equipment (UE), the relay wireless communication device 12 is exemplified as a relay UE that is a 5G ProSe Layer-3 UE-to-Network Relay, the interface 16 is a PC5 interface, the network node 24 is exemplified as implementing an AMF, the proximity services anchor node 30 is exemplified as implementing a ProSe Anchor Network Function (NF), and the authentication server 32 is exemplified as implementing an Authentication Server Function (AUSF). In some embodiments, the Prose Anchor Function is hosted by existing nodes e.g. co-located with the node that implements the ProSe Key Management Function (PKMF) or AAnF. Furthermore, the proximity services relay user key 26 is exemplified as a PRUK and the shared key 22 is exemplified as the key K_{NR_ProSe}.

The call flow in FIG. 4A-4B in this context describe security for 5G ProSe Communication via 5G ProSe Layer-3 (L3) UE-to-Network (U2N) Relay over control plane. The security mechanisms for the L3 U2N Relay authentication, authorization and key management use the primary authentication for PC5 keys establishment. In this procedure, the Remote UE establishes a PC5 link between the Remote UE and the UE-to-Network relay. The procedure includes how the Remote UE is authenticated by AUSF via Relay UE and Relay UE's AMF during 5G ProSe PC5 establishment. The mechanism can be used by a Remote UE while out of coverage.

0. The Remote UE and relay UE shall be registered with the network. The UE-to-Network relay shall be authenticated and authorized by the network to support as a relay UE. Remote UE shall be authenticated and authorized by the network to act as a Remote UE.

1. The remote UE shall initiate discovery procedure using any of Model A or Model B method as specified in clause 6.3.1.2 or 6.3.1.3 of TS 23.304 v. 17.0.0, respectively.

2-4. After the discovery of the UE-to-Network relay, the Remote UE shall send a Direct Communication Request (DCR) to the relay UE for establishing secure PC5 unicast link. The Remote UE shall include its security capabilities and security policy in the DCR message as specified in TS 33.536 v. 16.4.0. The message shall also include the SUbscription Concealed Identifier (SUCI) or PRUK ID, Relay Service Code (RSC), Nonce_1. Upon receiving the DCR message, the Relay UE shall send the relay key request to the relay AMF, including the parameters received in the DCR message. The Relay AMF shall verify whether the relay UE is authorized to act as U2N relay.

5. The relay AMF shall select Prose anchor Function (PANF) based on SUCI or PRUK ID and forward the key request to the PANF via Npanf_ProseKey_Request message. The message may include SUCI or PRUK ID, RSC, Nonce_1.

The Prose anchor Function (PANF) is located in Remote UE's Home Public Land Mobile Network (HPLMN) (as AUSF and UDM).

6. If SUCI is received, the PANF shall select AUSF based on SUCI and forward the key request to the AUSF via Nausf_UEAuthentication_ProseAuth Request message. The message may include SUCI, RSC, Nonce_1.

If PRUK ID is received, the PANF shall discover the PRUK stored locally and go step 13.

If PRUK ID is not valid or PRUK can't be found, the PANF sends an error message back to the UE via the relay AMF, which could trigger the remote UE repeat step 2 with SUCI.

7-10. The AUSF shall retrieve the Authentication Vectors from the UDM and trigger UE authentication of the remote UE.

11. On successful UE authentication, the AUSF and Remote UE shall generate 5GPRUK and PRUK ID based on the key material derived during UE authentication.

12. The AUSF shall send the SUPI of the remote UE, 5G PRUK and PRUK ID back to the PANF via Nausf_UEAuthentication_ProseAuth Response message

13. The PANF shall generate the Nonce_2, and derive K_{NR_ProSe} key based on 5G PRUK and Nonce_2.

The PANF (in remote UE's HPLMN) may also use the Nonce_1 and RSC as input when deriving the K_{NR_ProSe} key.

14. The PANF shall send K_{NR_ProSe}, Nonce_2 in Npanf_ProseKey_Response message to the relay AMF

15. The relay AMF forward K_{NR_ProSe}, Nonce_2 to the relay UE.

16. The relay UE shall send the received Nonce_2 to the Remote UE in Direct Security mode command message.

17-18. The remote UE shall generate the K_{NR_ProSe} key to be used for Remote access via the Relay UE in the same way as defined in step 13. The Remote UE shall send the Direct Security mode complete message to the UE-to-Network relay.

Further communication between Remote UE and Network takes place securely via the UE-to-Network relay.

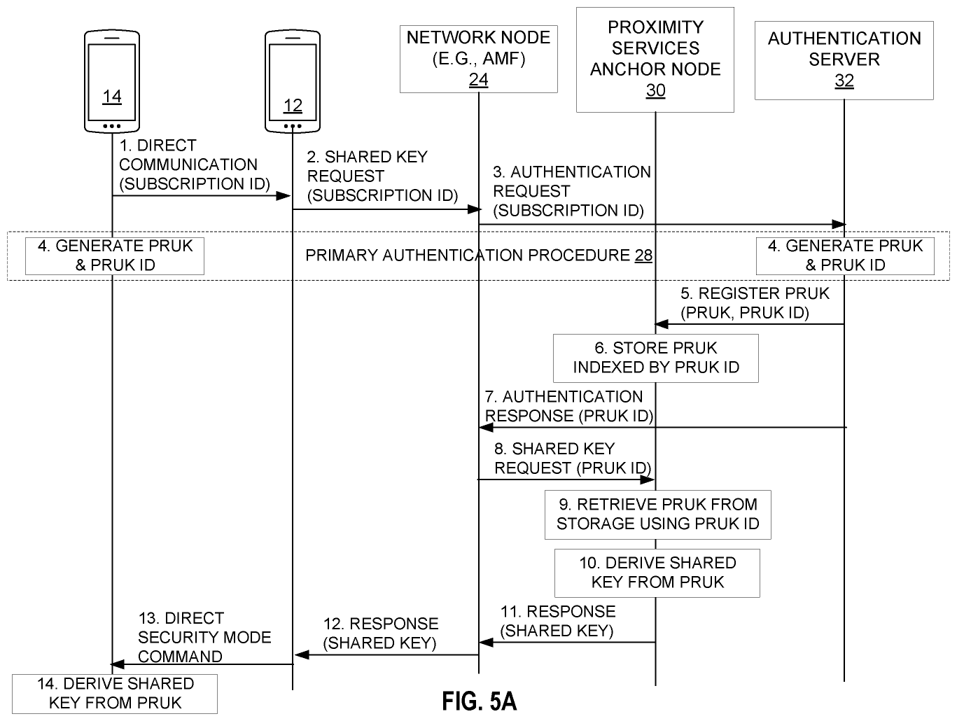

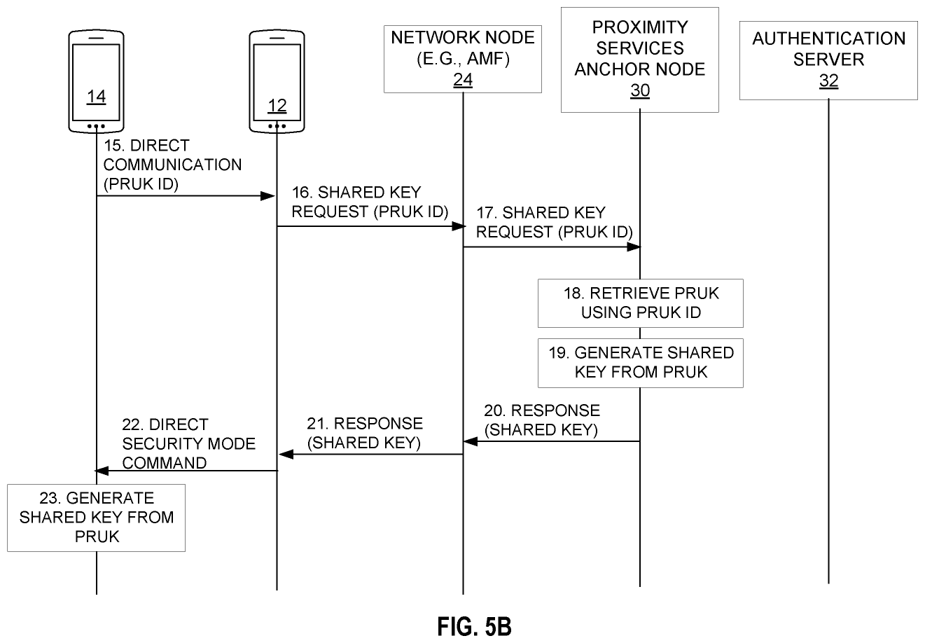

FIGS. 5A-5B show an example call flow according to yet other embodiments.

As depicted in FIG. 5A, the remote wireless communication device 14 sends a direct communication request to the relay wireless communication device 12 for establishing a secure unicast link over the interface 16 (Step 1). This direct communication request includes a subscription identifier (ID) which identifies a subscription to the wireless communication network 20. In order to establish the secure unicast link over the interface 16, the relay wireless communication device 12 correspondingly sends a shared key request to the network node 24 (e.g., AMF), where the shared key request requests the shared key 22 for protecting the interface 16 and includes the subscription identifier (Step 2). The network node 24 in these embodiments transmits a request for primary authentication of the remote wireless communication device 14 to the authentication server 32, where the authentication request includes the subscription ID (Step 3).

Based on the request, the authentication server 32 triggers a run of the primary authentication procedure 28, during which the remote wireless communication device 14 and the authentication server generate the proximity services relay user key (PRUK) 26 as well as an identifier 38 (shown as PRUK ID) bound to that proximity services relay user key (PRUK) 26 (Step 4). After this, the authentication server 32 registers the PRUK 26 and the identifier 38 bound to the PRUK 26 with the proximity services anchor node 30. In this regard, the authentication server 32 transmits, to the proximity services anchor node 30, a request to register the PRUK 26 with the proximity services anchor node 30, where the PRUK 26 is included in the request to register the PRUK 26 (Step 5). The request to register the PRUK 26 may also includes the identifier 38 bound to the PRUK 26 and/or also include the subscription identifier. The proximity services anchor 30 node according to this request stores the PRUK 26 in association with the identifier 38, e.g., stores the PRUK 26 indexed by the identifier 38 (Step 6). With the PRUK 26 registered with the proximity services anchor node 30, the authentication server 32 returns a response to the authentication request, including the identifier 38 (PRUK ID) (Step 7).

After registering the PRUK 26, the proximity services anchor node 30 receives, from the network node 24, a shared key request that indicates the identifier 38 bound to the PRUK 26 (Step 8). Using the identifier 38 indicated in the shared key request, the proximity services anchor node 30 retrieves the PRUK 26 from storage at the proximity services anchor node 30 (Step 9). The proximity services anchor node 30 then derives the shared key 22 from the PRUK 26 as retrieved from the storage (Step 10), and transmits the shared key 22 to the network node 24 in a response to the shared key request (Step 11).

The network node 24 receives the shared key 22 in the response and correspondingly transmits the shared key 22 to the relay wireless communication device 12, e.g., in a response to the shared key request from the relay wireless communication device 12 (Step 12).

The relay wireless communication device 12 as shown transmits a direct security mode command to the remote wireless communication device 14, e.g., including one or more other parameters such as a nonce from which the shared key 22 is derivable (Step 13). The remote wireless communication device 14 finally derives the shared key 22 from the PRUK 26 generated in step 5 (Step 14).

FIG. 5B shows the call flow diagram for reusing the PRUK 26 from FIG. 5A, e.g., for protecting subsequent establishment of an interface 16 between the remote wireless communication device 14 and the same or a different relay wireless communication device 12. As shown, the remote wireless communication device 14 transmits a direct communication request to the same or a different relay wireless communication device 12 (Step 15). This time, though, rather than including the subscription identifier for the remote wireless communication device 14, the direct communication request includes the identifier (PRUK ID) 38 bound to the PRUK 26. The relay wireless communication device 12 correspondingly transmits a shared key request to the network node 24 (Step 16). Since this is a subsequent shared key request, the shared key request effectively requests a fresh shared key that is different than the previous shared key used in FIG. 5A. Rather than including the subscription identifier, though, this fresh shared key request includes the identifier (PRUK ID) 38 bound to the PRUK 26. This means that the shared key request effectively requests that the PRUK 26 from FIG. 5A be re-used for deriving the fresh shared key. In any event, the network node 24 likewise transmits a corresponding shared key request to the proximity services anchor node 30 (Step 17).

The proximity services anchor node 30 receives the fresh shared key request. Using the identifier 38 indicated in the fresh shared key request, the proximity services anchor node 30 retrieves the PRUK 26 from storage at the proximity services anchor node 30 (Step 18). The proximity services anchor node 30 then re-uses the retrieved PRUK 26 to derive the fresh shared key 22 requested (Step 19). That is, rather than trigger primary authentication of the remote wireless communication device 14 via the authentication server 32, for generation of a new PRUK 26, the proximity services anchor node 30 re-uses the PRUK 26 generated from a previous run of the primary authentication procedure 28 in FIG. 5A. Moreover, with the PRUK 26 stored at the proximity services anchor node 30 and with reuse of the PRUK 26 accomplished by the proximity services anchor node 30, the authentication server 32 need not even be involved or impacted by reuse of the PRUK 26. In any event, the proximity services anchor node 30 then transmits the fresh shared key 22 to the network node 24 in response to the fresh shared key request (Step 20).

Similar to FIG. 5A, the network node 24 receives the shared key 22 in the response and correspondingly transmits the shared key 22 to the relay wireless communication device 12, e.g., in a response to the shared key request from the relay wireless communication device 12 (Step 21). The relay wireless communication device 12 again transmits a direct security mode command to the remote wireless communication device 14 (Step 22), and the remote wireless communication device 14 derives the shared key 22 from the re-used PRUK 26 that was generated in step 5 (Step 23).

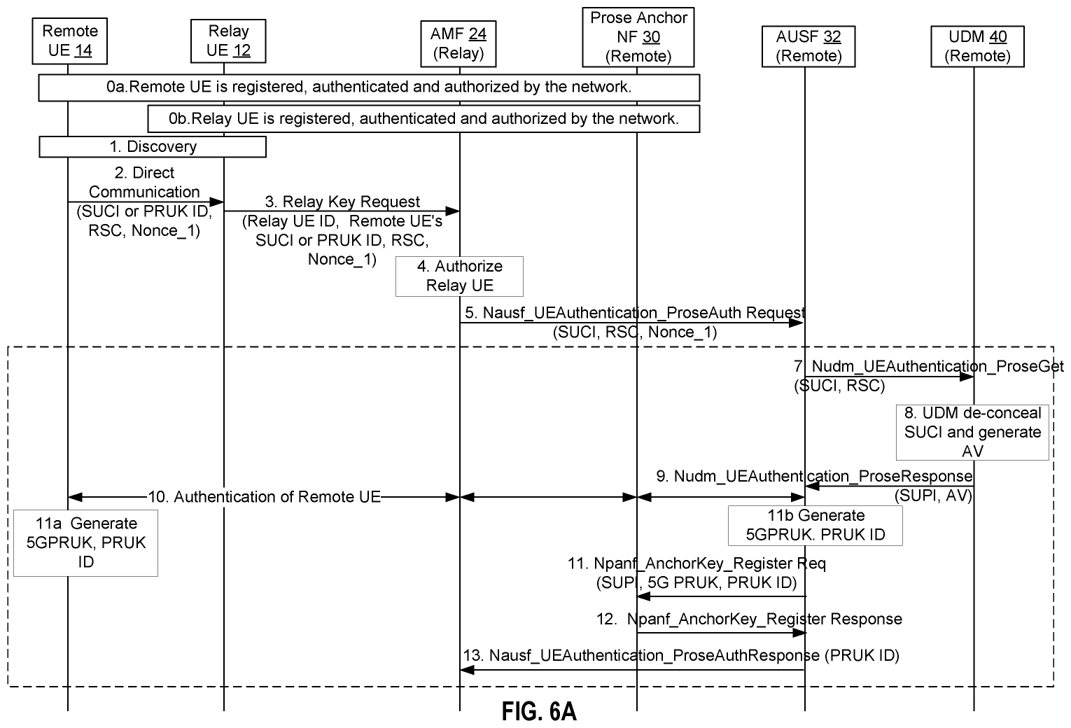

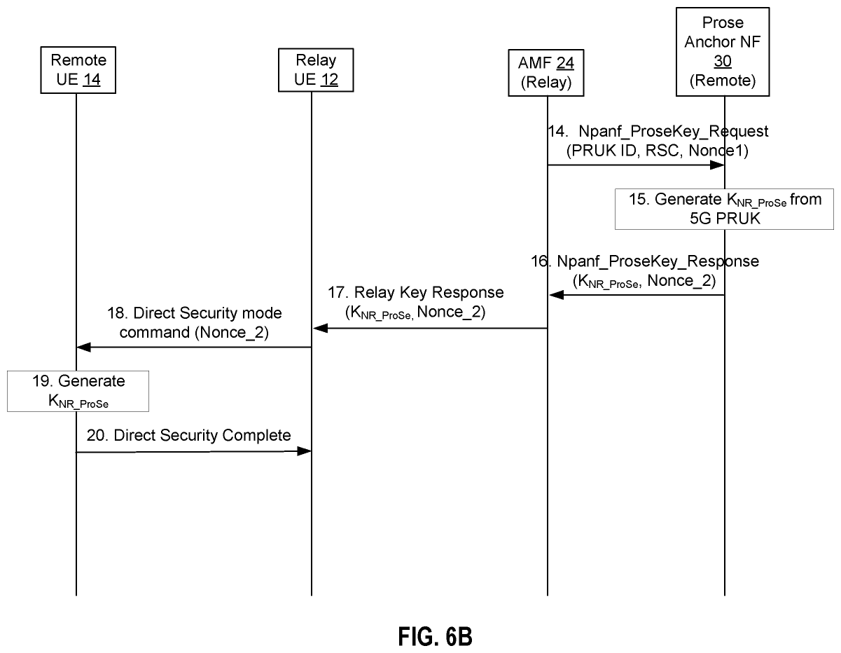

FIGS. 6A-6B illustrate a more detailed example of the embodiments from FIGS. 5A-5B, in the context where the wireless communication network 20 is a 5G network. In this example, the remote wireless communication device 14 is exemplified as a remote user equipment (UE), the relay wireless communication device 12 is exemplified as a relay UE that is a 5G ProSe Layer-3 UE-to-Network Relay, the interface 16 is a PC5 interface, the network node 24 is exemplified as implementing an AMF, the proximity services anchor node 30 is exemplified as implementing a ProSe Anchor Network Function (NF), and the authentication server 32 is exemplified as implementing an Authentication Server Function (AUSF). In some embodiments, the Prose Anchor Function is hosted by existing nodes e.g. co-located with the node that implements the ProSe Key Management Function (PKMF) or AAnF. Furthermore, the proximity services relay user key 26 is exemplified as a PRUK and the shared key 22 is exemplified as the key K_{NR_ProSe}.

The call flow in FIG. 6A-6B in this context describe security for 5G ProSe Communication via 5G ProSe Layer-3 (L3) UE-to-Network (U2N) Relay over control plane. The security mechanisms for the L3 U2N Relay authentication, authorization and key management use the primary authentication for PC5 keys establishment. In this procedure, the Remote UE establishes a PC5 link between the Remote UE and the UE-to-Network relay. The procedure includes how the Remote UE is authenticated by AUSF via Relay UE and Relay UE's AMF during 5G ProSe PC5 establishment. The mechanism can be used by a Remote UE while out of coverage.

Steps 1-4 in FIG. 6A are the same as Steps 1-4 in FIG. 4A.

5. If SUCI is received, the relay AMF shall select AUSF based on SUCI and forward the key request to the AUSF via Nausf_UEAuthentication_ProseAuth Request message. The message may include SUCI, RSC, Nonce_1.

If PRUK ID is received, the relay AMF shall discover the PANF (in Remote UE's HPLMN) based on PRUK ID and go step 14.

Steps 6-10 in FIG. 6A are the same as steps 7-11 in FIG. 4A.

11-12. The AUSF shall send the SUPI of the remote UE, 5G PRUK and PRUK ID to the PANF via Npanf_AnchorKey_Register request/response

13. The AUSF shall send PRUK ID back to the relay AMF via Nausf_UEAuthentication_ProseAuth Response message

14 The relay AMF shall send the Prose Key request to the PANF via Npanf_ProseKey_Request message. The message may include PRUK ID, RSC, Nonce_1. Steps 15-20 in FIG. 6B are the same as steps 13-18 in FIG. 4B.

Generally, then, FIGS. 3A-6B generally illustrate examples where a Prose Anchor Network Function stores the remote UE's prose security context, which can include the UE's 5G PRUK and PRUK ID, and optionally also the UE's Subscription Permanent Identifier (SUPI), so that the UE's prose security context and key material can be wholly managed by this NF, without bringing extra impacts to existing NFs, e.g. AUSF/UDM, AMF etc.

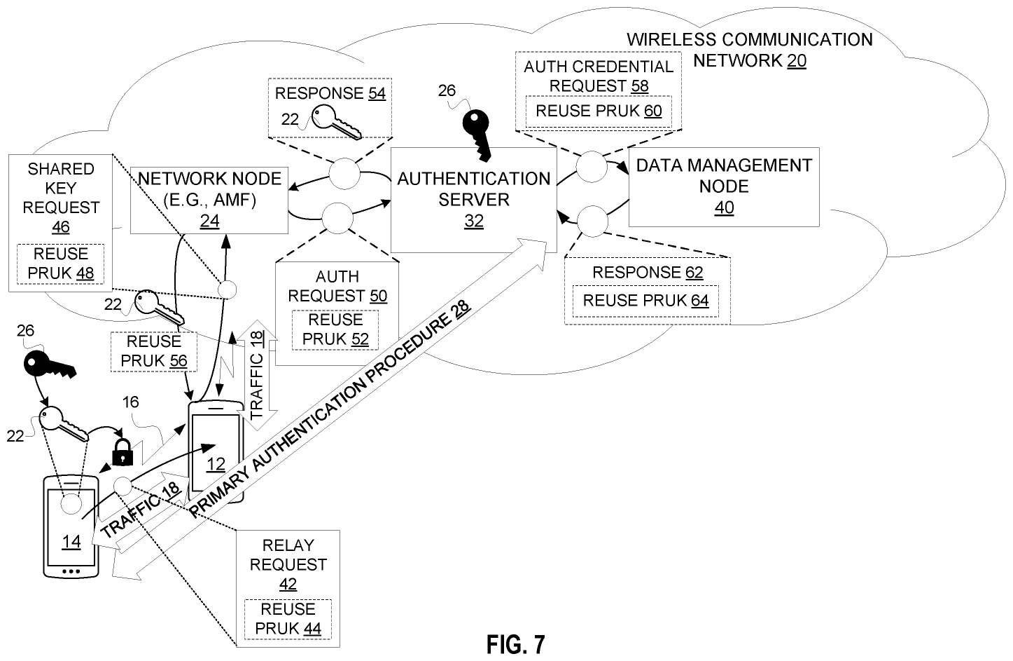

FIG. 7 illustrates other embodiments herein that exploit signaling for requesting or indicating reuse of the proximity services relay user key 26 that was last used. Such signaling may advantageously enable reuse of the proximity services relay user key 26 without having to bind an identifier 28 to that key 26, and therefore without requiring nodes such as the authentication server 32 to store or maintain that identifier 28. Correspondingly, such signaling may avoid introduction of the proximity services anchor node 30 in previous embodiments.

The description of FIG. 7 is similar to that of FIG. 1, except for the differences noted below. As shown in FIG. 7, the remote wireless communication device 14 transmits, to the relay wireless communication device 12, a request 42 for the relay wireless communication device 12 to relay traffic 18 for the remote wireless communication 12. This relay request 42 requests reuse of a proximity services relay user key 26 already associated with the remote wireless communication device 14. The request 42 may for example request reuse of a proximity services relay user key 24 from a previous run (e.g., the last run) of the primary authentication procedure 28 for primary authentication of the remote wireless communication device 14. The relay request 42 may for instance include a proximity services relay user key reuse flag 44 that requests reuse of the proximity services relay user key 26 already (e.g., last) associated with the remote wireless communication device 14.

The relay wireless communication device 12 correspondingly receives such a request 42 from the remote wireless communication device 14. The relay wireless communication device 12 in turn transmits, to the network node 24, a request 46 for a shared key 22 for protecting the interface 16, where the request 46 for the shared key 22 requests reuse of the proximity services relay user key 26 for deriving the shared key 22. For example, the request 46 for the shared key 22 may include a proximity services relay user key reuse flag 48 that requests reuse of the proximity services relay user key 26.

The network node 24 correspondingly receives the shared key request 42 from the relay wireless communication device 12. The network node 24 then transmits, to the authentication server 32, a request 50 for authentication of the remote wireless communication device 14, where the request 50 requests reuse of the proximity services relay user key 26 for deriving the shared key 22. The request 50 may for example include a proximity services relay user key reuse flag 52 that requests reuse of a proximity services relay user key 26 already associated with the remote wireless communication device 14.

The authentication server 32 correspondingly receives the authentication request 50. The authentication server 32 then transmits, to a data management node 40, a request 58 for authentication credentials for the remote wireless communication device 14, where the request 58 for authentication credentials requests reuse of the proximity services relay user key 26 for deriving the shared key 22. The authentication server 32 may in turn receive a response 62 to the request 58 for authentication credentials from the data management node 40, where the response 62 indicates whether the proximity services relay user key 26 is available for reuse.

If the response 62 indicates that the proximity services relay user key 26 is available for reuse, the authentication server 32 may retrieve the proximity services relay user key 26 from local storage at the authentication server 32, and reuse that proximity services relay user key 26 to derive the shared key 22. Or, the authentication server 32 may retrieve the shared key 22 from another authentication server (not shown) which was storing the proximity services relay user key 26 to be reused. Either way, after obtaining a shared key 22 derived through reuse of the proximity services relay user key 26, the authentication server 32 transmits, to the network node 24, a response 54 to the request for authentication, where the response 54 to the request 50 for authentication includes the derived shared key 22 and indicates that the proximity services relay user key 26 is to be reused for deriving the shared key 22. The network node 24 may correspondingly transmit, to the relay wireless communication device 12, a response to the shared key request 46, wherein the response includes the shared key 22 and indicates (e.g., via flag 56) that the proximity services relay user key 26 is to be reused for deriving the shared key 22. The relay wireless communication device 12 may similarly signal to the remote wireless communication device 14 that the proximity services relay user key 26 is to be reused for deriving the shared key 22. The remote wireless communication device 14 may then reuse the proximity services relay user key 26 for deriving the shared key 22.

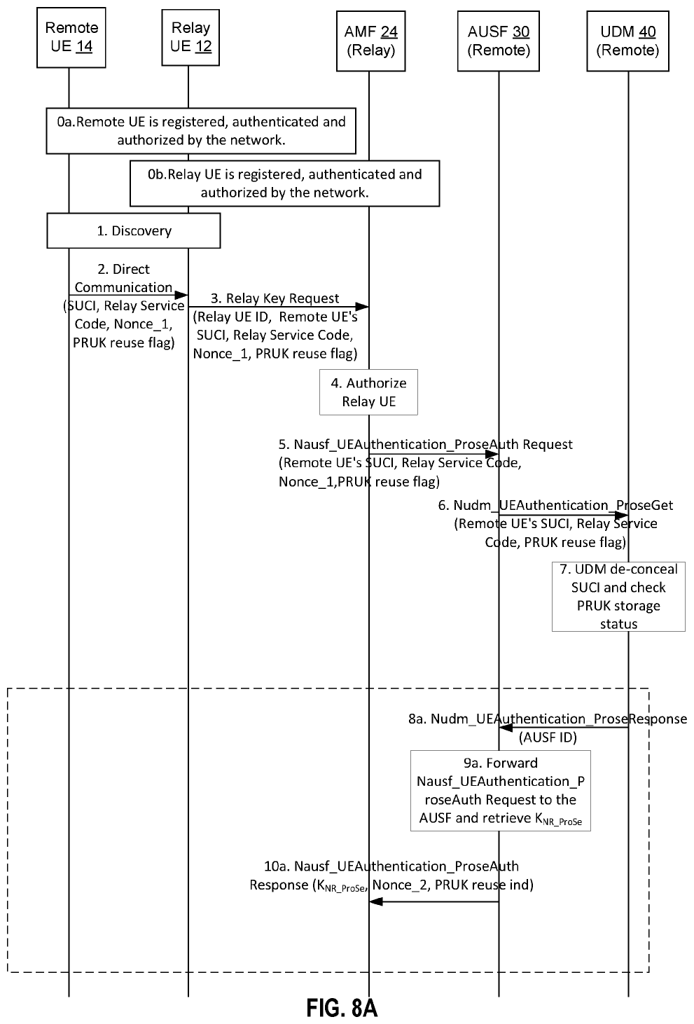

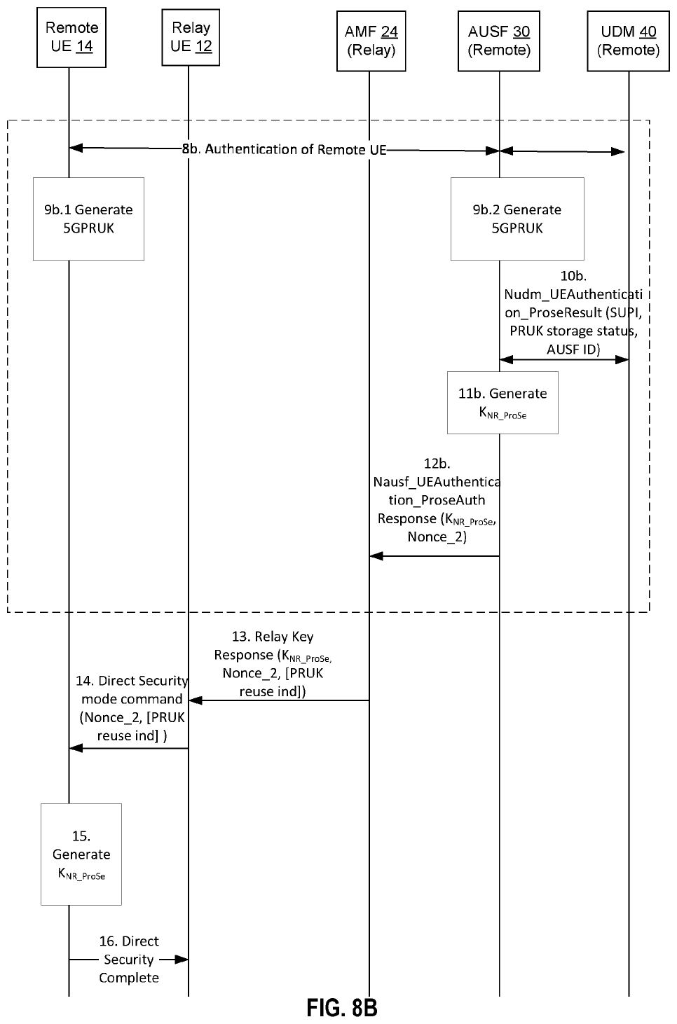

FIGS. 8A-8B illustrate a more detailed example of the embodiments from FIG. 7, in the context where the wireless communication network 20 is a 5G network. In this example, the remote wireless communication device 14 is exemplified as a remote user equipment (UE), the relay wireless communication device 12 is exemplified as a relay UE that is a 5G ProSe Layer-3 UE-to-Network Relay, the interface 16 is a PC5 interface, the network node 24 is exemplified as implementing an AMF, the authentication server 32 is exemplified as implementing an Authentication Server Function (AUSF), and the data management node 40 is exemplified as implementing a User Data Management (UDM) function. Furthermore, the proximity services relay user key 26 is exemplified as a PRUK and the shared key 22 is exemplified as the key K_{NR_ProSe}.

The call flow in FIG. 8A-8B in this context describe security for 5G ProSe Communication via 5G ProSe Layer-3 (L3) UE-to-Network (U2N) Relay over control plane. The security mechanisms for the L3 U2N Relay authentication, authorization and key management use the primary authentication for PC5 keys establishment. In this procedure, the Remote UE establishes a PC5 link between the Remote UE and the UE-to-Network relay. The procedure includes how the Remote UE is authenticated by AUSF via Relay UE and Relay UE's AMF during 5G ProSe PC5 establishment. The mechanism can be used by a Remote UE while out of coverage.

0. The Remote UE and relay UE shall be registered with the network. The UE-to-Network relay shall be authenticated and authorized by the network to support as a relay UE. Remote UE shall be authenticated and authorized by the network to act as a Remote UE.

1. The remote UE shall initiate discovery procedure

2-4. After the discovery of the UE-to-Network relay, the Remote UE shall send a Direct Communication Request to the relay UE for establishing secure PC5 unicast link. The Remote UE shall include its security capabilities and security policy in the DCR message as specified in TS 33.536 v. 16.4.0. The message shall also include SUCI, Relay Service Code (RSC), Nonce_1, and an indicator to indicate UE intends to reuse the PRUK obtained from previous interaction with the network, called PRUK_reuse_Flag herein. Upon receiving the DCR message, the Relay UE shall send the relay key request to the relay AMF, including the parameters received in the DCR message. The Relay AMF shall verify whether the relay UE is authorized to act as U2N relay.

5. The relay AMF shall select AUSF based on SUCI and forward the key request to the AUSF via Nausf_UEAuthentication_ProseAuth Request message. The message may include SUCI, RSC, Nonce_1 and PRUK_reuse_Flag.

6. The AUSF shall send the Authentication Credential request to the UDM, including SUCI and PRUK_reuse_Flag in the message.

7. The UDM deconceal the SUCI and get UE's SUPI;

If PRUK_reuse_Flag is received in the message, the UDM check the PRUK storage status for the UE.

There are two alternatives described below on how UDM proceeds.

Alternative 1: Step 8a which is followed by steps 9a and 10a below.

8a. If PRUK storage status indicates there exists PRUK stored for the UE and the AUSF instance that stores the PRUK (called AUSFpruk herein), the UDM sends the Authentication Credential Response to the AUSF with the AUSFpruk ID.

9a. If the AUSFpruk ID is the same instance of the AUSF, the AUSF fetch the 5G PRUK stored locally. The AUSF generate Nonce_2, and derive K_{NR_ProSe} key based on 5G PRUK.

If the AUSFpruk ID is another instance, the AUSF forwards the Nausf_UEAuthentication_ProseAuth Request message to the AUSFpruk. the AUSFpruk fetch the 5G PRUK stored locally. The AUSFpruk generate Nonce_2, and derive K_{NR_ProSe} key based on 5G PRUK, Nonce_1, Nonce_2 and RSC and send back the AUSF.

10a. The AUSF shall send K_{NR_ProSe}, Nonce_2, and an indicator to indicate that the network has used PRUK obtained from previous interaction (called PRUK_reuse_Ind herein) back to the relay AMF via Nausf_UEAuthentication_ProseAuth Response message

Alternative 2: Step 8b which is followed by steps 9b, 10b, 11b and 12b below:

8b. If PRUK storage status indicates there is no PRUK stored for the UE or the UDM determines PRUK shall not be reused, the UDM sends the Authentication Credential Response to the AUSF with UE's SUPI and Authentication vectors.

The AUSF proceeds with UE authentication procedure.

9b. On successful UE authentication, the AUSF and Remote UE shall generate 5GPRUK based on the key material derived during UE authentication.

10b. The AUSF stores the 5G PRUK and update the PRUK storage status to the UDM via message Nudm_UEAuthentication_ProseResult. The message may include SUPI, RSC, PRUK storage status and the AUSF ID.

11b. The AUSF generate Nonce_2, and derive K_{NR_ProS e} key based on 5G PRUK, Nonce_1, Nonce_2 and RSC.

12b. The AUSF shall send K_{NR_ProSe}, Nonce_2 back to the relay AMF via Nausf_UEAuthentication_ProseAuth Response message.

13. The relay AMF forward K_{NR_ProSe}, Nonce_2 to the relay UE. The message may contain PRUK_reuse_Ind.

14. The relay UE shall send the received Nonce_2 to the Remote UE in Direct Security mode command message. The message may contain PRUK_reuse_Ind.

15-16. The remote UE shall generate the K_{NR_ProSe} key to be used for Remote access via the Relay UE in the same way as the AUSF in step 9a/step 11b. The Remote UE shall send the Direct Security mode complete message to the UE-to-Network relay.

Further communication between Remote UE and Network takes place securely via the UE-to-Network relay.

Note that, in some embodiments, one or more of the keys in FIG. 2 may be derived using a Key Derivation Function (KDF) such that a derived key is equal to the KDF computed on a string S using a Key, as given by: derived key=HMAC-SHA-256 (Key, S). In one such embodiments, the string S is constructed from n+1 input parameters as follows:
S=FC∥P0∥L0∥P1∥L1∥P2∥L2∥P3∥L3∥ . . . ∥Pn∥Ln
   where FC is used to distinguish between different instances of the algorithm and is either a single octet or consists of two octets of the form FC1∥FC2 where FC1=0xFF and FC2 is a single octet, where P0 . . . Pn are the n+1 input parameter encodings, and L0 . . . Ln are the two-octet representations of the length of the corresponding input parameter encodings P0 . . . Pn.

In some embodiments, when deriving a 5GPRUK from KAUSF, the following parameters are used to form the input S to the KDF: FC=0xXX, P0=Subscription Permanent Identifier (SUPI), L0=length of SUPI, P1=relay service code, and L1=length of relay service code. The input key KEY is KAUSF.

Similarly, in some embodiments, when deriving the KNR_ProSe from 5GPRUK key, the following parameters are used to form the input S to the KDF: FC=0xZZ, P0=Nonce_2, L0=length of Nonce_2, P1=Nonce_1, and L1=length of Nonce_1. The input key KEY is 5GPRUK key.

Furthermore, when deriving the 5GPRUK ID from KAUSF, the following parameters may be used to form the input S to the KDF: FC=0xAA, P0=“PRUK-ID”, L0=length of “PRUK-ID”, P1=relay service code, L1=length of relay service code, P2=SUPI, and L2=length of SUPI. The input key KEY is KAUSF.

Although illustrated for simplicity as if the relay wireless communication device 12 is served by the remote wireless communication device's home network, such need not be the case. In other embodiments, for example, the relay wireless communication device 12 is served by a different wireless communication network than the remote wireless communication device's home network.

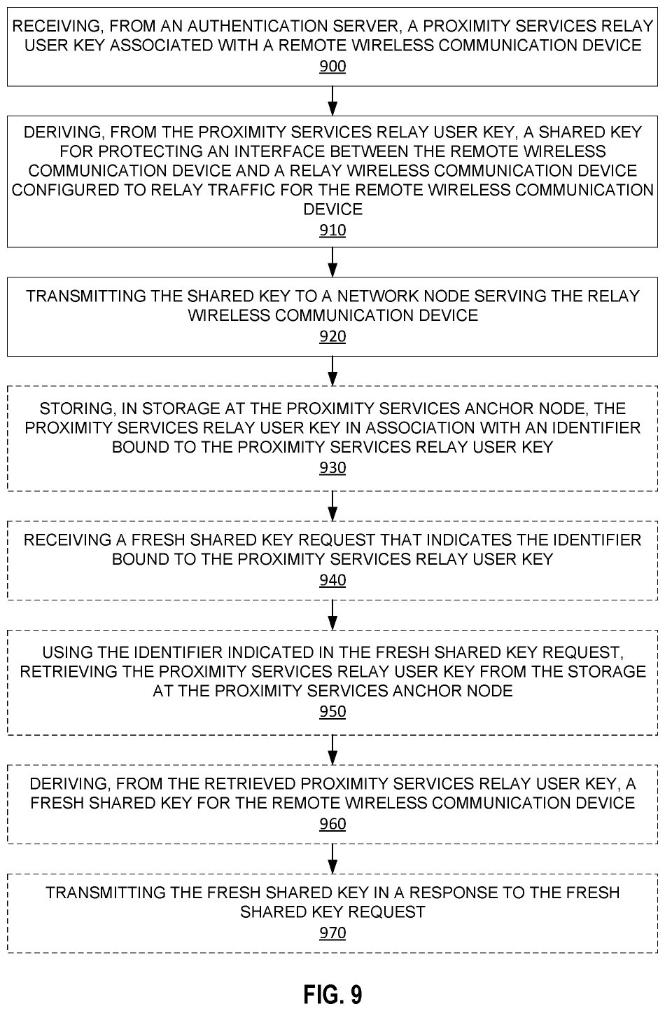

In view of the modifications and variations herein, FIG. 9 depicts a method performed by a proximity services anchor node in accordance with particular embodiments. The method includes receiving, from an authentication server, a proximity services relay user key associated with a remote wireless communication device (Block 900). The method further comprises deriving, from the proximity services relay user key, a shared key for protecting an interface between the remote wireless communication device and a relay wireless communication device configured to relay traffic for the remote wireless communication device (Block 910). The method also comprises transmitting the shared key to a network node serving the relay wireless communication device (Block 920).

In some embodiments, the proximity services relay user key is based on and/or is specific to a certain run of a primary authentication procedure for primary authentication of the remote wireless communication device.

In some embodiments, the method further comprises receiving, from the network node, a shared key request that requests the shared key from the proximity services anchor node, after receiving the shared key request, transmitting, to the authentication server, a request for primary authentication of the remote wireless communication device, and receiving, from the authentication server, a response to the request for primary authentication. In this case, the response to the request for primary authentication includes the proximity services relay user key. In one or more of these embodiments, the shared key request includes a subscription identifier that identifies a subscription of the remote wireless communication device to a home network of the remote wireless communication device. In one or more of these embodiments, the method further comprises transmitting, to the network node, a response to the shared key request. In this case, the response to the shared key request includes the shared key.

In some embodiments, the method further comprises storing, in storage at the proximity services anchor node, the proximity services relay user key in association with an identifier bound to the proximity services relay user key (Block 930). In one or more of these embodiments, the method further comprises receiving a fresh shared key request that indicates the identifier bound to the proximity services relay user key (Block 940). The method may further comprise using the identifier indicated in the fresh shared key request, retrieving the proximity services relay user key from the storage at the proximity services anchor node (Block 950) and deriving, from the retrieved proximity services relay user key, a fresh shared key for the remote wireless communication device (Block 960). The method may then comprise transmitting the fresh shared key in a response to the fresh shared key request (Block 970). For example, in some embodiments, the method further comprises receiving, from the authentication server, an identifier bound to the proximity services relay user key. In one or more of these embodiments, the method further comprises storing, in storage at the proximity services anchor node, the proximity services relay user key in association with the received identifier. In one or more of these embodiments, the method further comprises receiving, from a requesting node, a fresh shared key request that indicates the identifier bound to the proximity services relay user key, using the identifier indicated in the fresh shared key request, retrieving the proximity services relay user key from the storage at the proximity services anchor node, deriving, from the retrieved proximity services relay user key, a fresh shared key for the remote wireless communication device, and transmitted the fresh shared key to the requesting node in a response to the fresh shared key request. In one or more of these embodiments, the method further comprises storing the proximity services relay user key also in association with a subscription identifier that identifies a subscription of the remote wireless communication device to a home network of the remote wireless communication device.

In some embodiments, the method further comprises receiving, from the authentication server, a subscription identifier that identifies a subscription of the remote wireless communication device to a home network of the remote wireless communication device.

In some embodiments, the proximity services relay user key is received from the authentication server in a request to register the proximity services relay user key with the proximity services anchor node. In one or more of these embodiments, the request to register the proximity services relay user key also includes an identifier bound to the proximity services relay user key and/or also includes a subscription identifier that identifies a subscription of the remote wireless communication device to a home network of the remote wireless communication device. In one or more of these embodiments, the method further comprises storing, in storage at the proximity services anchor node, the proximity services relay user key in association with the received identifier. In one or more of these embodiments, the method further comprises after receiving the request to register the proximity services relay user key, receiving, from the network node, a shared key request that indicates the identifier bound to the proximity services relay user key, and using the identifier indicated in the shared key request, retrieving the proximity services relay user key from the storage at the proximity services anchor node. In this case, the shared key is derived from the proximity services relay user key as retrieved from the storage, and transmitting the shared key to the network node comprises transmitting, to the network node, a response to the shared key request, wherein the response includes the shared key.

In some embodiments, the proximity services relay user key is a 5G Proximity Services Relay User Key, 5GPRUK.

In some embodiments, the shared key is a key K_{NR_ProSe}.

In some embodiments, the authentication server implements an Authentication Server Function, AUSF.

In some embodiments, the network node implements an Access and Mobility Function, AMF.

In some embodiments, the interface is a PC5 interface.

In some embodiments, the relay wireless communication device is a Layer-3 UE-to-Network Relay.

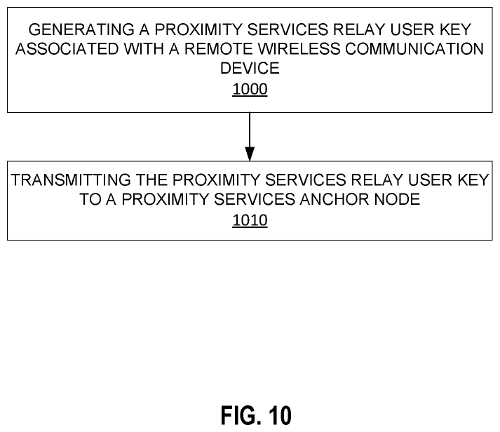

FIG. 10 depicts a method performed by an authentication server in accordance with other particular embodiments. The method includes generating a proximity services relay user key associated with a remote wireless communication device (Block 1000). The method also comprises transmitting the proximity services relay user key to a proximity services anchor node (Block 1010).

In some embodiments, the proximity services relay user key is based on and/or is specific to a certain run of a primary authentication procedure for primary authentication of the remote wireless communication device.

In some embodiments, the method further comprises receiving, from the proximity services anchor node, a request for primary authentication of the remote wireless communication device, and transmitting, to the proximity services anchor node, a response to the request for primary authentication, wherein the response to the request for primary authentication includes the proximity services relay user key. In one or more of these embodiments, the response also includes a subscription identifier that identifies a subscription of the remote wireless communication device to a home network of the remote wireless communication device.

In some embodiments, the method further comprises transmitting, the proximity services anchor node, an identifier bound to the proximity services relay user key.

In some embodiments, the method further comprises transmitting, to the proximity services anchor node, a subscription identifier that identifies a subscription of the remote wireless communication device to a home network of the remote wireless communication device.

In some embodiments, the method further comprises transmitting, to the proximity services anchor node, a request to register the proximity services relay user key with the proximity services anchor node. In this case, the proximity services relay user key is included in the request to register the proximity services relay user key. In one or more of these embodiments, the request to register the proximity services relay user key also includes an identifier bound to the proximity services relay user key and/or also includes a subscription identifier that identifies a subscription of the remote wireless communication device to a home network of the remote wireless communication device.

In some embodiments, the proximity services relay user key is a 5G Proximity Services Relay User Key, 5GPRUK.

In some embodiments, the authentication server implements an Authentication Server Function, AUSF.

In some embodiments, the proximity services relay user key is a credential from which is derivable a shared key for protecting an interface between the remote wireless communication device and a relay wireless communication device. In this case, the relay wireless communication device is configured to relay traffic for the remote wireless communication device. In one or more of these embodiments, the interface is a PC5 interface. In one or more of these embodiments, the relay wireless communication device is a Layer-3 UE-to-Network Relay.

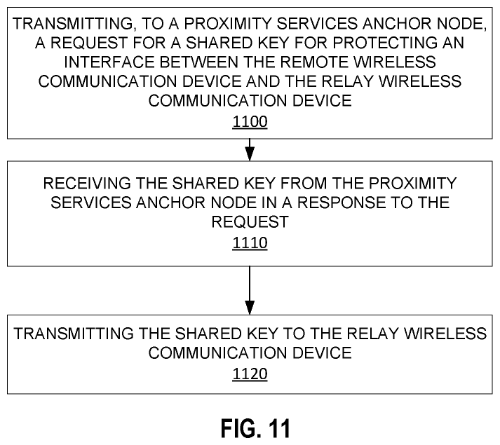

FIG. 11 depicts a method performed by a network node serving a relay wireless communication device configured to relay traffic for a remote wireless communication device in accordance with other particular embodiments. The method includes transmitting, to a proximity services anchor node, a request for a shared key for protecting an interface between the remote wireless communication device and the relay wireless communication device (Block 1100). The method also comprises receiving the shared key from the proximity services anchor node in a response to the request (Block 1110) and transmitting the shared key to the relay wireless communication device (Block 1120).

In some embodiments, the shared key is derivable from a proximity services relay user key. In this case, the proximity services relay user key is based on and/or is specific to a certain run of a primary authentication procedure for primary authentication of the remote wireless communication device.

In some embodiments, the shared key request includes an identifier bound to a proximity services relay user key. In this case, the received shared key is derived from the proximity services relay user key. In one or more of these embodiments, the proximity services relay user key is a 5G Proximity Services Relay User Key, 5GPRUK.

In some embodiments, the shared key request includes a subscription identifier that identifies a subscription of the remote wireless communication device to a home network of the remote wireless communication device.

In some embodiments, the shared key is a key K_{NR_ProSe}.

In some embodiments, the network node implements an Access and Mobility Function, AMF.

In some embodiments, the interface is a PC5 interface.

In some embodiments, the relay wireless communication device is a Layer-3 UE-to-Network Relay.

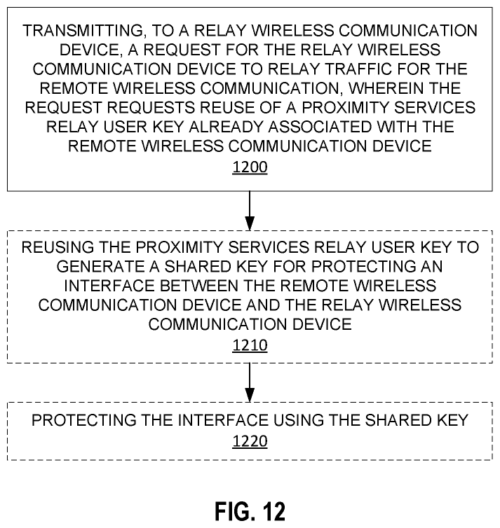

FIG. 12 depicts a method performed by a remote wireless communication device in accordance with other particular embodiments. The method comprises transmitting, to a relay wireless communication device, a request for the relay wireless communication device to relay traffic for the remote wireless communication (Block 1200). In this case, the request requests reuse of a proximity services relay user key already associated with the remote wireless communication device.

In some embodiments, the request requests reuse of a proximity services relay user key from a previous run of a primary authentication procedure for primary authentication of the remote wireless communication device.

In some embodiments, the request includes a proximity services relay user key reuse flag that requests reuse of a proximity services relay user key already associated with the remote wireless communication device.

In some embodiments, the proximity services relay user key is based on and/or is specific to a certain run of a primary authentication procedure for primary authentication of the remote wireless communication device.

In some embodiments, the method further comprises receiving, from the relay wireless communication device, a response to the request indicating that the proximity services relay user key is to be reused.

In some embodiments, the method further comprises reusing the proximity services relay user key to generate a shared key for protecting an interface between the remote wireless communication device and the relay wireless communication device (Block 1210), and protecting the interface using the shared key (Block 1220). In one or more of these embodiments, the shared key is a key K_{NR_ProSe}. In one or more of these embodiments, the interface is a PC5 interface.

In some embodiments, the proximity services relay user key is a 5G Proximity Services Relay User Key, 5GPRUK.

In some embodiments, the relay wireless communication device is a Layer-3 UE-to-Network Relay.

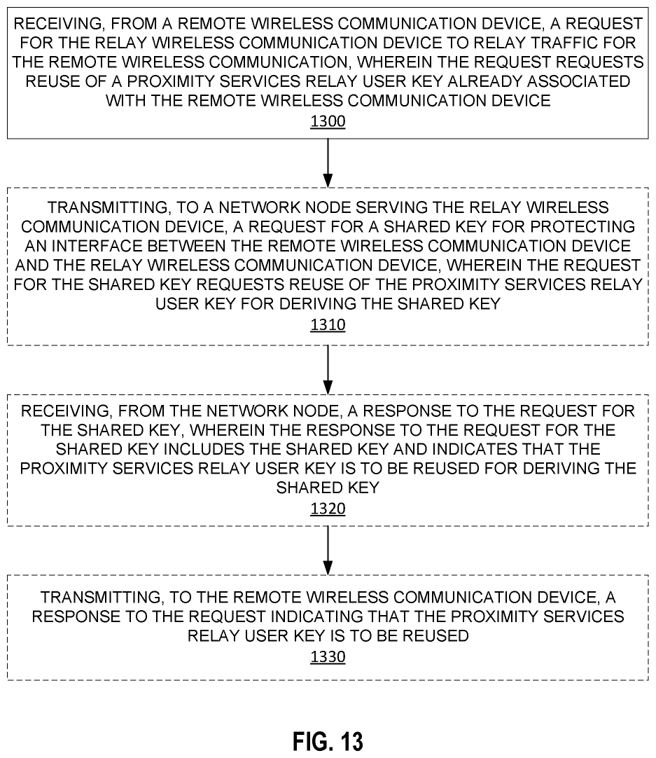

FIG. 13 depicts a method a method performed by a relay wireless communication device. The method comprises receiving, from a remote wireless communication device, a request for the relay wireless communication device to relay traffic for the remote wireless communication (Block 1300). In this case, the request requests reuse of a proximity services relay user key already associated with the remote wireless communication device.

In some embodiments, the request requests reuse of a proximity services relay user key from a previous run of a primary authentication procedure for primary authentication of the remote wireless communication device.

In some embodiments, the request includes a proximity services relay user key reuse flag that requests reuse of a proximity services relay user key already associated with the remote wireless communication device.

In some embodiments, the proximity services relay user key is based on and/or is specific to a certain run of a primary authentication procedure for primary authentication of the remote wireless communication device.

In some embodiments, the proximity services relay user key is a 5G Proximity Services Relay User Key, 5GPRUK.

In some embodiments, the relay wireless communication device is a Layer-3 UE-to-Network Relay.

In some embodiments, the method further comprises transmitting, to a network node serving the relay wireless communication device, a request for a shared key for protecting an interface between the remote wireless communication device and the relay wireless communication device (Block 1310). In this case, the request for the shared key requests reuse of the proximity services relay user key for deriving the shared key. In one or more of these embodiments, the request for the shared key includes a proximity services relay user key reuse flag that requests reuse of the proximity services relay user key. In one or more of these embodiments, the method further comprises receiving, from the network node, a response to the request for the shared key (Block 1320). In this case, the response to the request for the shared key includes the shared key and indicates that the proximity services relay user key is to be reused for deriving the shared key.

In some embodiments, the method further comprises transmitting, to the remote wireless communication device, a response to the request indicating that the proximity services relay user key is to be reused (Block 1330).

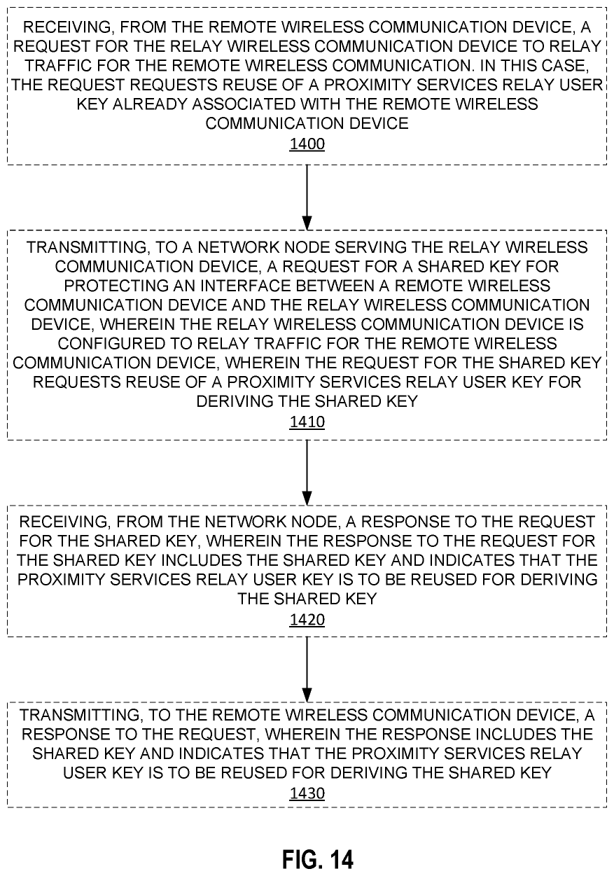

FIG. 14 depicts a method performed by a relay wireless communication device. In some embodiments, the method comprises transmitting, to a network node serving the relay wireless communication device, a request for a shared key for protecting an interface between a remote wireless communication device and the relay wireless communication device (Block 1410). In this case, the relay wireless communication device is configured to relay traffic for the remote wireless communication device, and the request for the shared key requests reuse of a proximity services relay user key for deriving the shared key.

In some embodiments, the request for the shared key includes a proximity services relay user key reuse flag that requests reuse of the proximity services relay user key.

In some embodiments, the method comprises receiving, from the network node, a response to the request for the shared key (Block 1420). In this case, the response to the request for the shared key includes the shared key and indicates that the proximity services relay user key is to be reused for deriving the shared key.

In some embodiments, the request requests reuse of a proximity services relay user key from a previous run of a primary authentication procedure for primary authentication of the remote wireless communication device.

In some embodiments, the proximity services relay user key is based on and/or is specific to a certain run of a primary authentication procedure for primary authentication of the remote wireless communication device.

In some embodiments, the method comprises receiving, from the remote wireless communication device, a request for the relay wireless communication device to relay traffic for the remote wireless communication (Block 1400). In this case, the request requests reuse of a proximity services relay user key already associated with the remote wireless communication device. The method in some embodiments further comprises transmitting, to the remote wireless communication device, a response to the request (Block 1430). In this case, the response includes the shared key and indicates that the proximity services relay user key is to be reused for deriving the shared key.

In some embodiments, the proximity services relay user key is a 5G Proximity Services Relay User Key, 5GPRUK.

In some embodiments, the relay wireless communication device is a Layer-3 UE-to-Network Relay.

In some embodiments, the shared key is a key K_{NR_ProSe}.

In some embodiments, the network node implements an Access and Mobility Function, AMF.

In some embodiments, the interface is a PC5 interface.

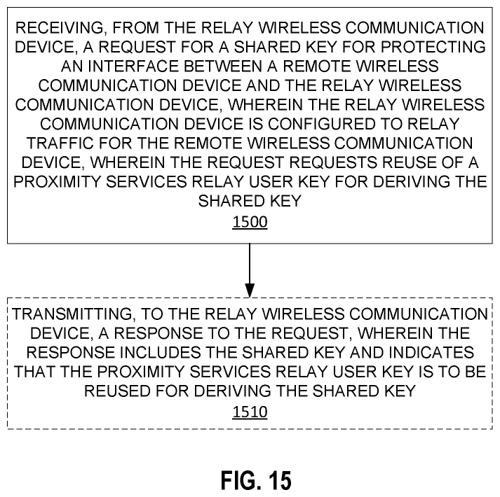

FIG. 15 shows a method performed by a network node serving a relay wireless communication device. The method comprises receiving, from the relay wireless communication device, a request for a shared key for protecting an interface between a remote wireless communication device and the relay wireless communication device (Block 1500). In this case, the relay wireless communication device is configured to relay traffic for the remote wireless communication device, and the request requests reuse of a proximity services relay user key for deriving the shared key.

In some embodiments, the request requests reuse of a proximity services relay user key from a previous run of a primary authentication procedure for primary authentication of the remote wireless communication device.

In some embodiments, the request includes a proximity services relay user key reuse flag that requests reuse of a proximity services relay user key already associated with the remote wireless communication device.

In some embodiments, the proximity services relay user key is based on and/or is specific to a certain run of a primary authentication procedure for primary authentication of the remote wireless communication device.

In some embodiments, the method further comprises transmitting, to the relay wireless communication device, a response to the request (Block 1510). In this case, the response includes the shared key and indicates that the proximity services relay user key is to be reused for deriving the shared key.

In some embodiments, the proximity services relay user key is a 5G Proximity Services Relay User Key, 5GPRUK.

In some embodiments, the relay wireless communication device is a Layer-3 UE-to-Network Relay.

In some embodiments, the shared key is a key K_{NR_ProSe}.

In some embodiments, the network node implements an Access and Mobility Function, AMF.

In some embodiments, the interface is a PC5 interface.

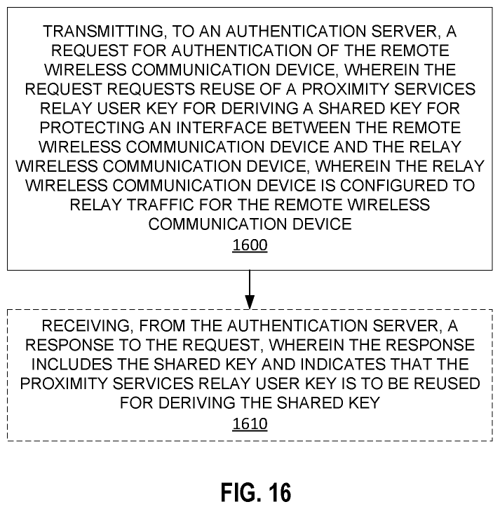

FIG. 16 shows a method performed by a network node serving a relay wireless communication device. The method comprises transmitting, to an authentication server, a request for authentication of the remote wireless communication device (Block 1600). In this case, the request requests reuse of a proximity services relay user key for deriving a shared key for protecting an interface between the remote wireless communication device and the relay wireless communication device, and the relay wireless communication device is configured to relay traffic for the remote wireless communication device.

In some embodiments, the request requests reuse of a proximity services relay user key from a previous run of a primary authentication procedure for primary authentication of the remote wireless communication device.

In some embodiments, the request includes a proximity services relay user key reuse flag that requests reuse of a proximity services relay user key already associated with the remote wireless communication device.

In some embodiments, the proximity services relay user key is based on and/or is specific to a certain run of a primary authentication procedure for primary authentication of the remote wireless communication device.

In some embodiments, the method further comprises receiving, from the authentication server, a response to the request (Block 1610). In this case, the response includes the shared key and indicates that the proximity services relay user key is to be reused for deriving the shared key.

In some embodiments, the proximity services relay user key is a 5G Proximity Services Relay User Key, 5GPRUK.

In some embodiments, the relay wireless communication device is a Layer-3 UE-to-Network Relay.

In some embodiments, the shared key is a key K_{NR_ProSe}.

In some embodiments, the network node implements an Access and Mobility Function, AMF.

In some embodiments, the interface is a PC5 interface.

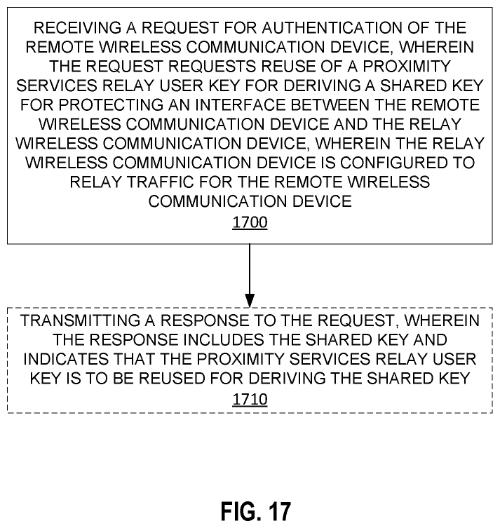

FIG. 17 shows a method performed by an authentication server. The method comprises receiving a request for authentication of a remote wireless communication device (Block 1700). In this case, the request requests reuse of a proximity services relay user key for deriving a shared key for protecting an interface between the remote wireless communication device and a relay wireless communication device, where the relay wireless communication device is configured to relay traffic for the remote wireless communication device.

In some embodiments, the request requests reuse of a proximity services relay user key from a previous run of a primary authentication procedure for primary authentication of the remote wireless communication device.

In some embodiments, the request includes a proximity services relay user key reuse flag that requests reuse of a proximity services relay user key already associated with the remote wireless communication device.

In some embodiments, the proximity services relay user key is based on and/or is specific to a certain run of a primary authentication procedure for primary authentication of the remote wireless communication device.

In some embodiments, the method further comprises transmitting a response to the request (Block 1710). In this case, the response includes the shared key and indicates that the proximity services relay user key is to be reused for deriving the shared key.

In some embodiments, the proximity services relay user key is a 5G Proximity Services Relay User Key, 5GPRUK.

In some embodiments, the relay wireless communication device is a Layer-3 UE-to-Network Relay.

In some embodiments, the shared key is a key K_{NR_ProSe}.

In some embodiments, the request is received from an Access and Mobility Function, AMF.

In some embodiments, the interface is a PC5 interface.

In some embodiments, the method further comprises transmitting, to a data management node, a request for authentication credentials for the remote wireless communication device. In this case, the request for authentication credentials requests reuse of the proximity services relay user key. In one or more of these embodiments, the method further comprises receiving a response to the request for authentication credentials from the data management node. In this case, the response indicates whether the proximity services relay user key is available for reuse. In one or more of these embodiments, the response indicates that the proximity services relay user key is available for reuse. In this case, the method further comprises obtaining the shared key as derived from the proximity services relay user key, and transmitting a response to the request for authentication. In this case, the response to the request for authentication includes the obtained shared key and indicates that the proximity services relay user key is to be reused for deriving the shared key. In one or more of these embodiments, obtaining the shared key comprises retrieving the proximity services relay user key from local storage at the authentication server and deriving the shared key from the retrieved proximity services relay user key. In one or more of these embodiments, obtaining the shared key comprises forwarding the request for authentication to another authentication server at which the proximity services relay user key is stored, and receiving, from the another authentication server, the shared key as derived from the proximity services relay user key. In one or more of these embodiments, the response indicates that the proximity services relay user key is not available for reuse and includes the requested authentication credentials. In this case, the method further comprises generating a proximity services relay user key based on key material derived during authentication of the remote wireless communication device, wherein the authentication of the remote wireless communication device is based on the authentication credentials, deriving the shared key from the generated proximity services relay user key, and transmitting a response to the request for authentication. In this case, the response to the request for authentication includes the derived shared key. In one or more of these embodiments, the response to the request for authentication indicates that the proximity services relay user key is not to be reused for deriving the shared key. Alternatively or additionally, the method may further comprise, after generating the proximity services relay user key, transmitting, to the data management node, signaling indicating that a proximity services relay user key for the remote wireless communication device is available for reuse and indicating the identity of the authentication server at which the proximity services relay user key is stored.

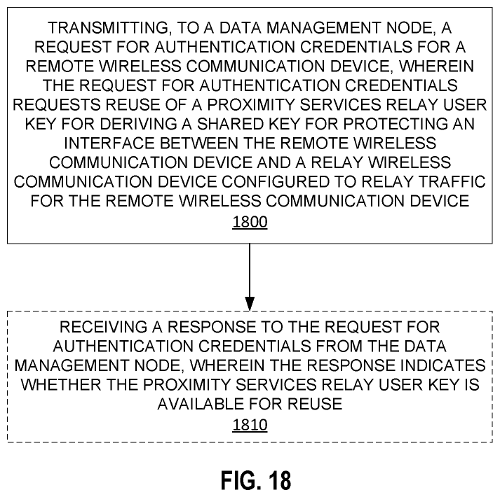

FIG. 18 depicts a method performed by an authentication server. The method comprises transmitting, to a data management node, a request for authentication credentials for a remote wireless communication device (Block 1800). In this case, the request for authentication credentials requests reuse of a proximity services relay user key for deriving a shared key for protecting an interface between the remote wireless communication device and a relay wireless communication device configured to relay traffic for the remote wireless communication device.

In some embodiments, the request is received from a network node serving the relay wireless communication device. In other embodiments, the request is received from another authentication server.

In some embodiments, the method further comprises receiving a response to the request for authentication credentials from the data management node (Block 1810). In this case, the response indicates whether the proximity services relay user key is available for reuse. In one or more of these embodiments, the response indicates that the proximity services relay user key is available for reuse. In this case, the method further comprises obtaining the shared key as derived from the proximity services relay user key, and transmitting, to a network node, a response to a request for authentication. In this case, the response to the request for authentication includes the obtained shared key and indicates that the proximity services relay user key is to be reused for deriving the shared key. In one or more of these embodiments, obtaining the shared key comprises retrieving the proximity services relay user key from local storage at the authentication server and deriving the shared key from the retrieved proximity services relay user key. In one or more of these embodiments, obtaining the shared key comprises forwarding the request for authentication to another authentication server at which the proximity services relay user key is stored, and receiving, from the another authentication server, the shared key as derived from the proximity services relay user key.

In some embodiments, the response indicates that the proximity services relay user key is not available for reuse and includes the requested authentication credentials. In this case, the method further comprises generating a proximity services relay user key based on key material derived during authentication of the remote wireless communication device. In this case, the authentication of the remote wireless communication device is based on the authentication credentials. The method further comprises deriving the shared key from the generated proximity services relay user key, and transmitting, to a network node, a response to a request for authentication. In this case, the response to the request for authentication includes the derived shared key. In one or more of these embodiments, the response to the request for authentication indicates that the proximity services relay user key is not to be reused for deriving the shared key.

In some embodiments, the proximity services relay user key is a 5G Proximity Services Relay User Key, 5GPRUK.

In some embodiments, the relay wireless communication device is a Layer-3 UE-to-Network Relay.

In some embodiments, the shared key is a key K_{NR_ProSe}.

In some embodiments, the network node implements an Access and Mobility Function, AMF.

In some embodiments, the interface is a PC5 interface.

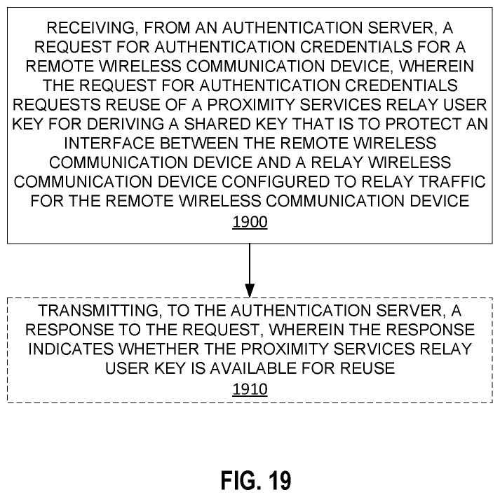

FIG. 19 shows a method performed by a data management node. The method comprises receiving, from an authentication server, a request for authentication credentials for a remote wireless communication device (Block 1900). In this case, the request for authentication credentials requests reuse of a proximity services relay user key for deriving a shared key that is to protect an interface between the remote wireless communication device and a relay wireless communication device configured to relay traffic for the remote wireless communication device.

In some embodiments, the method further comprises transmitting, to the authentication server, a response to the request (Block 1910). In this case, the response indicates whether the proximity services relay user key is available for reuse. In one or more of these embodiments, the response indicates that the proximity services relay user key is available for reuse. In one or more of these embodiments, the response indicates an identity of an authentication server at which the proximity services relay user key is stored. In one or more of these embodiments, the response indicates that the proximity services relay user key is not available for reuse and includes the requested authentication credentials. In one or more of these embodiments, the method further comprises, after transmitting the response, receiving signaling indicating an identity of an authentication server at which a proximity services relay user key is stored, and storing information at the data management node indicating that a proximity services relay user key for the remote wireless communication device is available for reuse and indicating the identity of the authentication server at which the proximity services relay user key is stored.

In some embodiments, the method further comprises checking whether the proximity services relay user key is available for reuse, based on information at the data management node indicating whether any proximity services relay user key is stored for the remote wireless communication device.

In some embodiments, the proximity services relay user key is a 5G Proximity Services Relay User Key, 5GPRUK.

In some embodiments, the relay wireless communication device is a Layer-3 UE-to-Network Relay.

In some embodiments, the shared key is a key K_{NR_ProSe}.

In some embodiments, the interface is a PC5 interface.

Embodiments herein also include corresponding apparatuses. Embodiments herein for instance include a wireless communication device configured to perform any of the steps of any of the embodiments described above for the remote wireless communication device or the relay wireless communication device.

Embodiments also include a wireless communication device comprising processing circuitry and power supply circuitry. The processing circuitry is configured to perform any of the steps of any of the embodiments described above for the remote wireless communication device or the relay wireless communication device. The power supply circuitry is configured to supply power to the wireless communication device.

Embodiments further include a wireless communication device comprising processing circuitry. The processing circuitry is configured to perform any of the steps of any of the embodiments described above for the remote wireless communication device or the relay wireless communication device. In some embodiments, the wireless communication device further comprises communication circuitry.

Embodiments further include a wireless communication device comprising processing circuitry and memory. The memory contains instructions executable by the processing circuitry whereby the wireless communication device is configured to perform any of the steps of any of the embodiments described above for the remote wireless communication device or the relay wireless communication device.

Embodiments moreover include a user equipment (UE). The UE comprises an antenna configured to send and receive wireless signals. The UE also comprises radio front-end circuitry connected to the antenna and to processing circuitry, and configured to condition signals communicated between the antenna and the processing circuitry. The processing circuitry is configured to perform any of the steps of any of the embodiments described above for the remote wireless communication device or the relay wireless communication device. In some embodiments, the UE also comprises an input interface connected to the processing circuitry and configured to allow input of information into the UE to be processed by the processing circuitry. The UE may comprise an output interface connected to the processing circuitry and configured to output information from the UE that has been processed by the processing circuitry. The UE may also comprise a battery connected to the processing circuitry and configured to supply power to the UE.

Embodiments herein also include a proximity services anchor node configured to perform any of the steps of any of the embodiments described above for the proximity services anchor node.

Embodiments also include a proximity services anchor node comprising processing circuitry and power supply circuitry. The processing circuitry is configured to perform any of the steps of any of the embodiments described above for the proximity services anchor node. The power supply circuitry is configured to supply power to the proximity services anchor node

Embodiments further include a proximity services anchor node comprising processing circuitry. The processing circuitry is configured to perform any of the steps of any of the embodiments described above for the proximity services anchor node. In some embodiments, the proximity services anchor node further comprises communication circuitry.

Embodiments further include a proximity services anchor node comprising processing circuitry and memory. The memory contains instructions executable by the processing circuitry whereby the proximity services anchor node is configured to perform any of the steps of any of the embodiments described above for the proximity services anchor node.

Embodiments herein also include an authentication server configured to perform any of the steps of any of the embodiments described above for the authentication server.

Embodiments also include an authentication server comprising processing circuitry and power supply circuitry. The processing circuitry is configured to perform any of the steps of any of the embodiments described above for the authentication server. The power supply circuitry is configured to supply power to the authentication server

Embodiments further include an authentication server comprising processing circuitry. The processing circuitry is configured to perform any of the steps of any of the embodiments described above for the authentication server. In some embodiments, the authentication server further comprises communication circuitry.

Embodiments further include an authentication server comprising processing circuitry and memory. The memory contains instructions executable by the processing circuitry whereby the authentication server is configured to perform any of the steps of any of the embodiments described above for the authentication server.

Embodiments herein also include a network node 24 configured to perform any of the steps of any of the embodiments described above for the network node 24.

Embodiments also include an authentication server comprising processing circuitry and power supply circuitry. The processing circuitry is configured to perform any of the steps of any of the embodiments described above for the network node 24. The power supply circuitry is configured to supply power to the network node 24

Embodiments further include a network node 24 comprising processing circuitry. The processing circuitry is configured to perform any of the steps of any of the embodiments described above for the network node 24. In some embodiments, the network node 24 further comprises communication circuitry.

Embodiments further include a network node 24 comprising processing circuitry and memory. The memory contains instructions executable by the processing circuitry whereby the network node 24 is configured to perform any of the steps of any of the embodiments described above for the network node 24.

Embodiments herein also include a data management node 40 configured to perform any of the steps of any of the embodiments described above for the data management node 40.

Embodiments also include a data management node 40 comprising processing circuitry and power supply circuitry. The processing circuitry is configured to perform any of the steps of any of the embodiments described above for the data management node 40. The power supply circuitry is configured to supply power to the data management node 40.

Embodiments further include a data management node 40 comprising processing circuitry. The processing circuitry is configured to perform any of the steps of any of the embodiments described above for the data management node 40. In some embodiments, the data management node 40 further comprises communication circuitry.

Embodiments further include a data management node 40 comprising processing circuitry and memory. The memory contains instructions executable by the processing circuitry whereby the data management node 40 is configured to perform any of the steps of any of the embodiments described above for the data management node 40.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

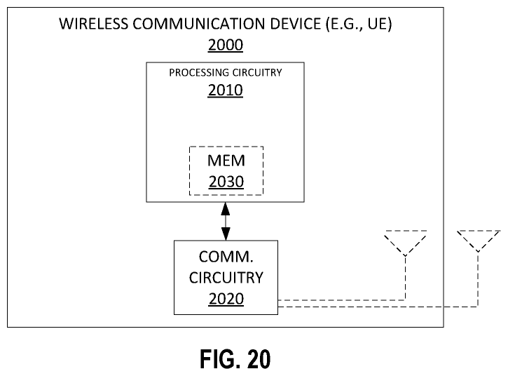

FIG. 20 for example illustrates a wireless communication device 2000 as implemented in accordance with one or more embodiments. The wireless communication device 2000 may be the remote wireless communication device or the relay wireless communication device. As shown, the wireless communication device 2000 includes processing circuitry 2010 and communication circuitry 2020. The communication circuitry 2020 (e.g., radio circuitry) is configured to transmit and/or receive information to and/or from one or more other nodes, e.g., via any communication technology. Such communication may occur via one or more antennas that are either internal or external to the wireless communication device 2000. The processing circuitry 2010 is configured to perform processing described above, e.g., in FIG. 12, FIG. 13, and/or FIG. 14, such as by executing instructions stored in memory 2030. The processing circuitry 2010 in this regard may implement certain functional means, units, or modules.

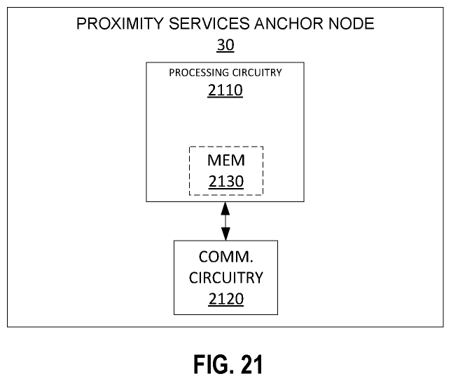

FIG. 21 illustrates a proximity services anchor node 30 as implemented in accordance with one or more embodiments. As shown, the proximity services anchor node 30 includes processing circuitry 2110 and communication circuitry 2120. The communication circuitry 2120 is configured to transmit and/or receive information to and/or from one or more other nodes, e.g., via any communication technology. The processing circuitry 2110 is configured to perform processing described above, e.g., in FIG. 9, such as by executing instructions stored in memory 2130. The processing circuitry 2110 in this regard may implement certain functional means, units, or modules.

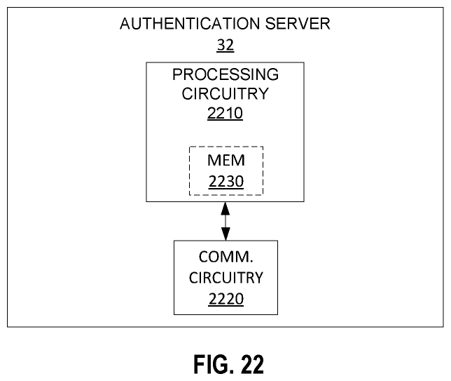

FIG. 22 illustrates an authentication server 32 as implemented in accordance with one or more embodiments. As shown, the authentication server 32 includes processing circuitry 2210 and communication circuitry 2220. The communication circuitry 2220 is configured to transmit and/or receive information to and/or from one or more other nodes, e.g., via any communication technology. The processing circuitry 2210 is configured to perform processing described above, e.g., in FIG. 10, FIG. 17, and/or FIG. 18, such as by executing instructions stored in memory 2230. The processing circuitry 2210 in this regard may implement certain functional means, units, or modules.

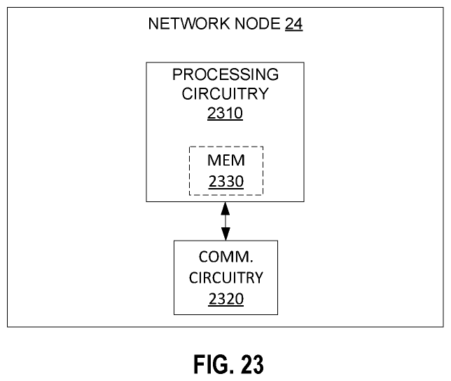

FIG. 23 illustrates a network node 24 as implemented in accordance with one or more embodiments. As shown, the network node 24 includes processing circuitry 2310 and communication circuitry 2320. The communication circuitry 2320 is configured to transmit and/or receive information to and/or from one or more other nodes, e.g., via any communication technology. The processing circuitry 2310 is configured to perform processing described above, e.g., in FIG. 11, FIG. 15, and/or FIG. 16, such as by executing instructions stored in memory 2330. The processing circuitry 2310 in this regard may implement certain functional means, units, or modules.

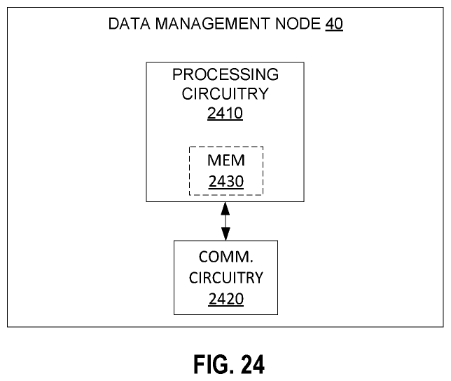

FIG. 24 illustrates a data management node 40 as implemented in accordance with one or more embodiments. As shown, the data management node 40 includes processing circuitry 2410 and communication circuitry 2420. The communication circuitry 2420 is configured to transmit and/or receive information to and/or from one or more other nodes, e.g., via any communication technology. The processing circuitry 2410 is configured to perform processing described above, e.g., in FIG. 19, such as by executing instructions stored in memory 2430. The processing circuitry 2410 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

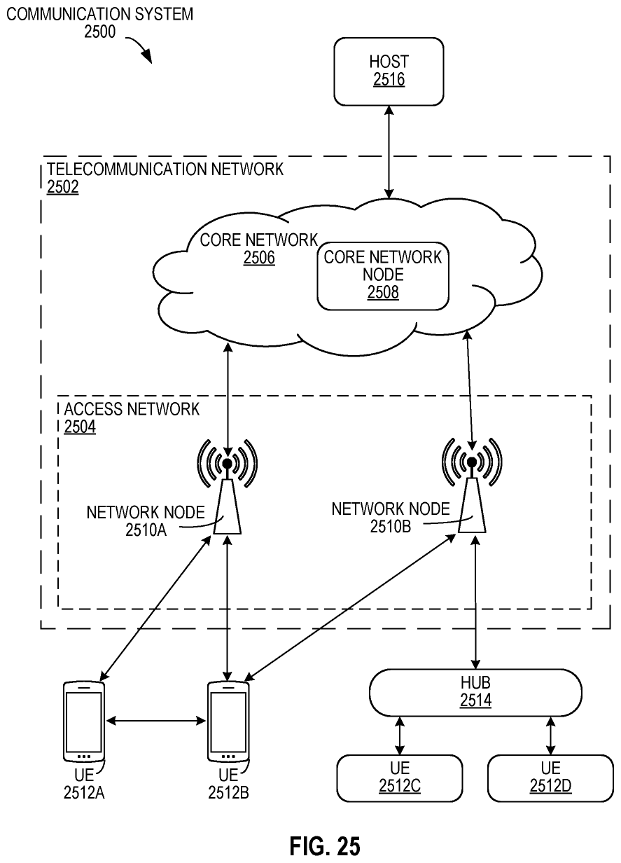

FIG. 25 shows an example of a communication system 2500 in accordance with some embodiments.

In the example, the communication system 2500 includes a telecommunication network 2502 that includes an access network 2504, such as a radio access network (RAN), and a core network 2506, which includes one or more core network nodes 2508. The access network 2504 includes one or more access network nodes, such as network nodes 2510a and 2510b (one or more of which may be generally referred to as network nodes 2510), or any other similar 3^{rd} Generation Partnership Project (3GPP) access node or non-3GPP access point. The network nodes 2510 facilitate direct or indirect connection of user equipment (UE), such as by connecting UEs 2512a, 2512b, 2512c, and 2512d (one or more of which may be generally referred to as UEs 2512) to the core network 2506 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 2500 may include any number of wired or wireless networks, network nodes, UEs, and/or any other components or systems that may facilitate or participate in the communication of data and/or signals whether via wired or wireless connections. The communication system 2500 may include and/or interface with any type of communication, telecommunication, data, cellular, radio network, and/or other similar type of system.

The UEs 2512 may be any of a wide variety of communication devices, including wireless devices arranged, configured, and/or operable to communicate wirelessly with the network nodes 2510 and other communication devices. Similarly, the network nodes 2510 are arranged, capable, configured, and/or operable to communicate directly or indirectly with the UEs 2512 and/or with other network nodes or equipment in the telecommunication network 2502 to enable and/or provide network access, such as wireless network access, and/or to perform other functions, such as administration in the telecommunication network 2502.

In the depicted example, the core network 2506 connects the network nodes 2510 to one or more hosts, such as host 2516. These connections may be direct or indirect via one or more intermediary networks or devices. In other examples, network nodes may be directly coupled to hosts. The core network 2506 includes one more core network nodes (e.g., core network node 2508) that are structured with hardware and software components. Features of these components may be substantially similar to those described with respect to the UEs, network nodes, and/or hosts, such that the descriptions thereof are generally applicable to the corresponding components of the core network node 2508. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 2516 may be under the ownership or control of a service provider other than an operator or provider of the access network 2504 and/or the telecommunication network 2502, and may be operated by the service provider or on behalf of the service provider. The host 2516 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 2500 of FIG. 25 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 2502 is a cellular network that implements 3GPP standardized features. Accordingly, the telecommunications network 2502 may support network slicing to provide different logical networks to different devices that are connected to the telecommunication network 2502. For example, the telecommunications network 2502 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 2512 are configured to transmit and/or receive information without direct human interaction. For instance, a UE may be designed to transmit information to the access network 2504 on a predetermined schedule, when triggered by an internal or external event, or in response to requests from the access network 2504. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 2514 communicates with the access network 2504 to facilitate indirect communication between one or more UEs (e.g., UE 2512c and/or 2512d) and network nodes (e.g., network node 2510b). In some examples, the hub 2514 may be a controller, router, content source and analytics, or any of the other communication devices described herein regarding UEs. For example, the hub 2514 may be a broadband router enabling access to the core network 2506 for the UEs. As another example, the hub 2514 may be a controller that sends commands or instructions to one or more actuators in the UEs. Commands or instructions may be received from the UEs, network nodes 2510, or by executable code, script, process, or other instructions in the hub 2514. As another example, the hub 2514 may be a data collector that acts as temporary storage for UE data and, in some embodiments, may perform analysis or other processing of the data. As another example, the hub 2514 may be a content source. For example, for a UE that is a VR headset, display, loudspeaker or other media delivery device, the hub 2514 may retrieve VR assets, video, audio, or other media or data related to sensory information via a network node, which the hub 2514 then provides to the UE either directly, after performing local processing, and/or after adding additional local content. In still another example, the hub 2514 acts as a proxy server or orchestrator for the UEs, in particular in if one or more of the UEs are low energy IoT devices.

The hub 2514 may have a constant/persistent or intermittent connection to the network node 2510b. The hub 2514 may also allow for a different communication scheme and/or schedule between the hub 2514 and UEs (e.g., UE 2512c and/or 2512d), and between the hub 2514 and the core network 2506. In other examples, the hub 2514 is connected to the core network 2506 and/or one or more UEs via a wired connection. Moreover, the hub 2514 may be configured to connect to an M2M service provider over the access network 2504 and/or to another UE over a direct connection. In some scenarios, UEs may establish a wireless connection with the network nodes 2510 while still connected via the hub 2514 via a wired or wireless connection. In some embodiments, the hub 2514 may be a dedicated hub—that is, a hub whose primary function is to route communications to/from the UEs from/to the network node 2510b. In other embodiments, the hub 2514 may be a non-dedicated hub—that is, a device which is capable of operating to route communications between the UEs and network node 2510b, but which is additionally capable of operating as a communication start and/or end point for certain data channels.

FIG. 26 shows a UE 2600 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 2600 includes processing circuitry 2602 that is operatively coupled via a bus 2604 to an input/output interface 2606, a power source 2608, a memory 2610, a communication interface 2612, and/or any other component, or any combination thereof. Certain UEs may utilize all or a subset of the components shown in FIG. 26. The level of integration between the components may vary from one UE to another UE. Further, certain UEs may contain multiple instances of a component, such as multiple processors, memories, transceivers, transmitters, receivers, etc.

The processing circuitry 2602 is configured to process instructions and data and may be configured to implement any sequential state machine operative to execute instructions stored as machine-readable computer programs in the memory 2610. The processing circuitry 2602 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 2602 may include multiple central processing units (CPUs).

In the example, the input/output interface 2606 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 2600. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 2608 is structured as a battery or battery pack. Other types of power sources, such as an external power source (e.g., an electricity outlet), photovoltaic device, or power cell, may be used. The power source 2608 may further include power circuitry for delivering power from the power source 2608 itself, and/or an external power source, to the various parts of the UE 2600 via input circuitry or an interface such as an electrical power cable. Delivering power may be, for example, for charging of the power source 2608. Power circuitry may perform any formatting, converting, or other modification to the power from the power source 2608 to make the power suitable for the respective components of the UE 2600 to which power is supplied.

The memory 2610 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 2610 includes one or more application programs 2614, such as an operating system, web browser application, a widget, gadget engine, or other application, and corresponding data 2616. The memory 2610 may store, for use by the UE 2600, any of a variety of various operating systems or combinations of operating systems.

The memory 2610 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 2610 may allow the UE 2600 to access instructions, application programs and the like, stored on transitory or non-transitory memory media, to off-load data, or to upload data. An article of manufacture, such as one utilizing a communication system may be tangibly embodied as or in the memory 2610, which may be or comprise a device-readable storage medium.

The processing circuitry 2602 may be configured to communicate with an access network or other network using the communication interface 2612. The communication interface 2612 may comprise one or more communication subsystems and may include or be communicatively coupled to an antenna 2622. The communication interface 2612 may include one or more transceivers used to communicate, such as by communicating with one or more remote transceivers of another device capable of wireless communication (e.g., another UE or a network node in an access network). Each transceiver may include a transmitter 2618 and/or a receiver 2620 appropriate to provide network communications (e.g., optical, electrical, frequency allocations, and so forth). Moreover, the transmitter 2618 and receiver 2620 may be coupled to one or more antennas (e.g., antenna 2622) and may share circuit components, software or firmware, or alternatively be implemented separately.

In the illustrated embodiment, communication functions of the communication interface 2612 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 2612, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 2600 shown in FIG. 26.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

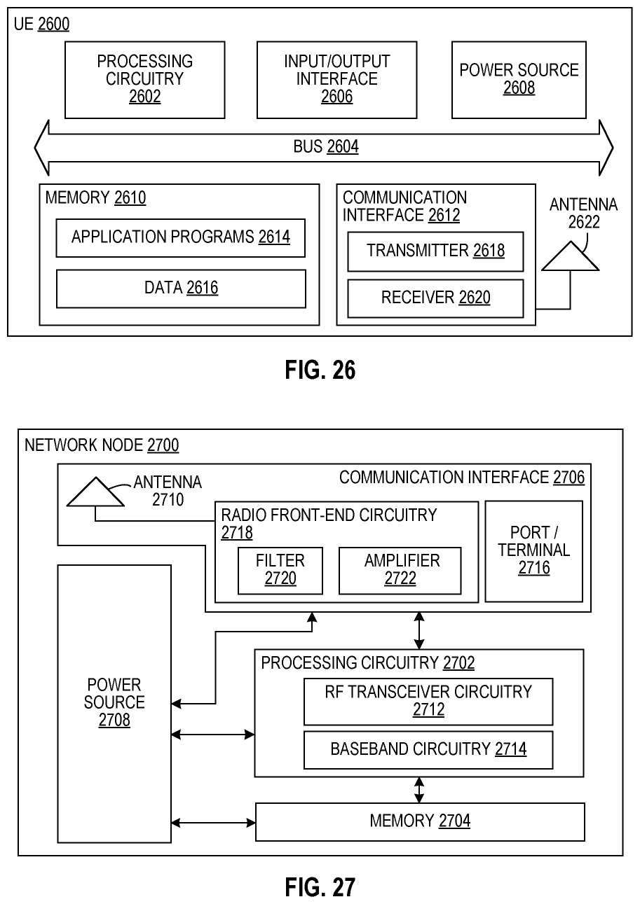

FIG. 27 shows a network node 2700 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 2700 includes a processing circuitry 2702, a memory 2704, a communication interface 2706, and a power source 2708. The network node 2700 may be composed of multiple physically separate components (e.g., a NodeB component and a RNC component, or a BTS component and a BSC component, etc.), which may each have their own respective components. In certain scenarios in which the network node 2700 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 2700 may be configured to support multiple radio access technologies (RATs). In such embodiments, some components may be duplicated (e.g., separate memory 2704 for different RATs) and some components may be reused (e.g., a same antenna 2710 may be shared by different RATs). The network node 2700 may also include multiple sets of the various illustrated components for different wireless technologies integrated into network node 2700, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 2700.

The processing circuitry 2702 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 2700 components, such as the memory 2704, to provide network node 2700 functionality.

In some embodiments, the processing circuitry 2702 includes a system on a chip (SOC). In some embodiments, the processing circuitry 2702 includes one or more of radio frequency (RF) transceiver circuitry 2712 and baseband processing circuitry 2714. In some embodiments, the radio frequency (RF) transceiver circuitry 2712 and the baseband processing circuitry 2714 may be on separate chips (or sets of chips), boards, or units, such as radio units and digital units. In alternative embodiments, part or all of RF transceiver circuitry 2712 and baseband processing circuitry 2714 may be on the same chip or set of chips, boards, or units.

The memory 2704 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 2702. The memory 2704 may store any suitable instructions, data, or information, including a computer program, software, an application including one or more of logic, rules, code, tables, and/or other instructions capable of being executed by the processing circuitry 2702 and utilized by the network node 2700. The memory 2704 may be used to store any calculations made by the processing circuitry 2702 and/or any data received via the communication interface 2706. In some embodiments, the processing circuitry 2702 and memory 2704 is integrated.

The communication interface 2706 is used in wired or wireless communication of signaling and/or data between a network node, access network, and/or UE. As illustrated, the communication interface 2706 comprises port(s)/terminal(s) 2716 to send and receive data, for example to and from a network over a wired connection. The communication interface 2706 also includes radio front-end circuitry 2718 that may be coupled to, or in certain embodiments a part of, the antenna 2710. Radio front-end circuitry 2718 comprises filters 2720 and amplifiers 2722. The radio front-end circuitry 2718 may be connected to an antenna 2710 and processing circuitry 2702. The radio front-end circuitry may be configured to condition signals communicated between antenna 2710 and processing circuitry 2702. The radio front-end circuitry 2718 may receive digital data that is to be sent out to other network nodes or UEs via a wireless connection. The radio front-end circuitry 2718 may convert the digital data into a radio signal having the appropriate channel and bandwidth parameters using a combination of filters 2720 and/or amplifiers 2722. The radio signal may then be transmitted via the antenna 2710. Similarly, when receiving data, the antenna 2710 may collect radio signals which are then converted into digital data by the radio front-end circuitry 2718. The digital data may be passed to the processing circuitry 2702. In other embodiments, the communication interface may comprise different components and/or different combinations of components.

In certain alternative embodiments, the network node 2700 does not include separate radio front-end circuitry 2718, instead, the processing circuitry 2702 includes radio front-end circuitry and is connected to the antenna 2710. Similarly, in some embodiments, all or some of the RF transceiver circuitry 2712 is part of the communication interface 2706. In still other embodiments, the communication interface 2706 includes one or more ports or terminals 2716, the radio front-end circuitry 2718, and the RF transceiver circuitry 2712, as part of a radio unit (not shown), and the communication interface 2706 communicates with the baseband processing circuitry 2714, which is part of a digital unit (not shown).

The antenna 2710 may include one or more antennas, or antenna arrays, configured to send and/or receive wireless signals. The antenna 2710 may be coupled to the radio front-end circuitry 2718 and may be any type of antenna capable of transmitting and receiving data and/or signals wirelessly. In certain embodiments, the antenna 2710 is separate from the network node 2700 and connectable to the network node 2700 through an interface or port.

The antenna 2710, communication interface 2706, and/or the processing circuitry 2702 may be configured to perform any receiving operations and/or certain obtaining operations described herein as being performed by the network node. Any information, data and/or signals may be received from a UE, another network node and/or any other network equipment. Similarly, the antenna 2710, the communication interface 2706, and/or the processing circuitry 2702 may be configured to perform any transmitting operations described herein as being performed by the network node. Any information, data and/or signals may be transmitted to a UE, another network node and/or any other network equipment.

The power source 2708 provides power to the various components of network node 2700 in a form suitable for the respective components (e.g., at a voltage and current level needed for each respective component). The power source 2708 may further comprise, or be coupled to, power management circuitry to supply the components of the network node 2700 with power for performing the functionality described herein. For example, the network node 2700 may be connectable to an external power source (e.g., the power grid, an electricity outlet) via an input circuitry or interface such as an electrical cable, whereby the external power source supplies power to power circuitry of the power source 2708. As a further example, the power source 2708 may comprise a source of power in the form of a battery or battery pack which is connected to, or integrated in, power circuitry. The battery may provide backup power should the external power source fail.

Embodiments of the network node 2700 may include additional components beyond those shown in FIG. 27 for providing certain aspects of the network node's functionality, including any of the functionality described herein and/or any functionality necessary to support the subject matter described herein. For example, the network node 2700 may include user interface equipment to allow input of information into the network node 2700 and to allow output of information from the network node 2700. This may allow a user to perform diagnostic, maintenance, repair, and other administrative functions for the network node 2700.

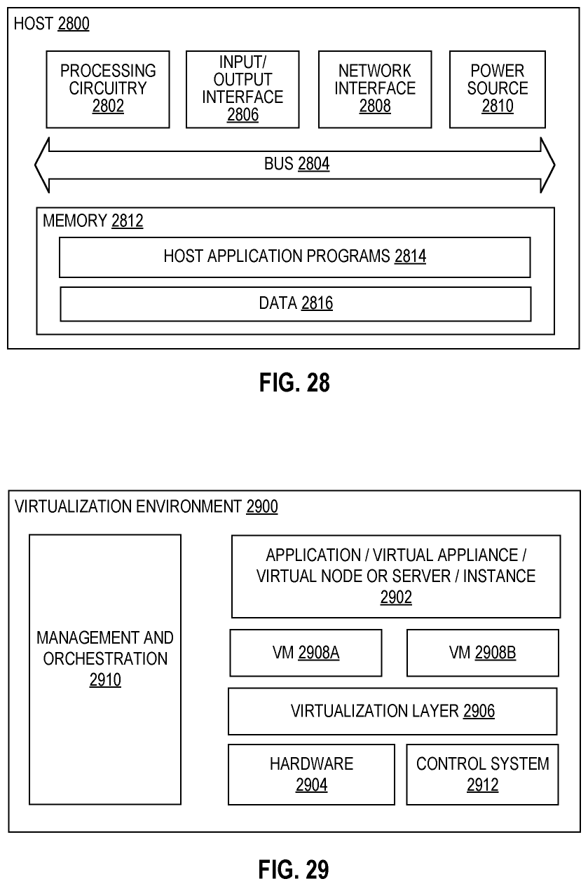

FIG. 28 is a block diagram of a host 2800, which may be an embodiment of the host 2516 of FIG. 25, in accordance with various aspects described herein. As used herein, the host 2800 may be or comprise various combinations hardware and/or software, including a standalone server, a blade server, a cloud-implemented server, a distributed server, a virtual machine, container, or processing resources in a server farm. The host 2800 may provide one or more services to one or more UEs.

The host 2800 includes processing circuitry 2802 that is operatively coupled via a bus 2804 to an input/output interface 2806, a network interface 2808, a power source 2810, and a memory 2812. Other components may be included in other embodiments. Features of these components may be substantially similar to those described with respect to the devices of previous figures, such as FIGS. 26 and 27, such that the descriptions thereof are generally applicable to the corresponding components of host 2800.

The memory 2812 may include one or more computer programs including one or more host application programs 2814 and data 2816, which may include user data, e.g., data generated by a UE for the host 2800 or data generated by the host 2800 for a UE. Embodiments of the host 2800 may utilize only a subset or all of the components shown. The host application programs 2814 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 2814 may also provide for user authentication and licensing checks and may periodically report health, routes, and content availability to a central node, such as a device in or on the edge of a core network. Accordingly, the host 2800 may select and/or indicate a different host for over-the-top services for a UE. The host application programs 2814 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 29 is a block diagram illustrating a virtualization environment 2900 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2900 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2902 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 2904 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2906 (also referred to as hypervisors or virtual machine monitors (VMMs)), provide VMs 2908a and 2908b (one or more of which may be generally referred to as VMs 2908), and/or perform any of the functions, features and/or benefits described in relation with some embodiments described herein. The virtualization layer 2906 may present a virtual operating platform that appears like networking hardware to the VMs 2908.

The VMs 2908 comprise virtual processing, virtual memory, virtual networking or interface and virtual storage, and may be run by a corresponding virtualization layer 2906. Different embodiments of the instance of a virtual appliance 2902 may be implemented on one or more of VMs 2908, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 2908 may be a software implementation of a physical machine that runs programs as if they were executing on a physical, non-virtualized machine. Each of the VMs 2908, and that part of hardware 2904 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2908 on top of the hardware 2904 and corresponds to the application 2902.

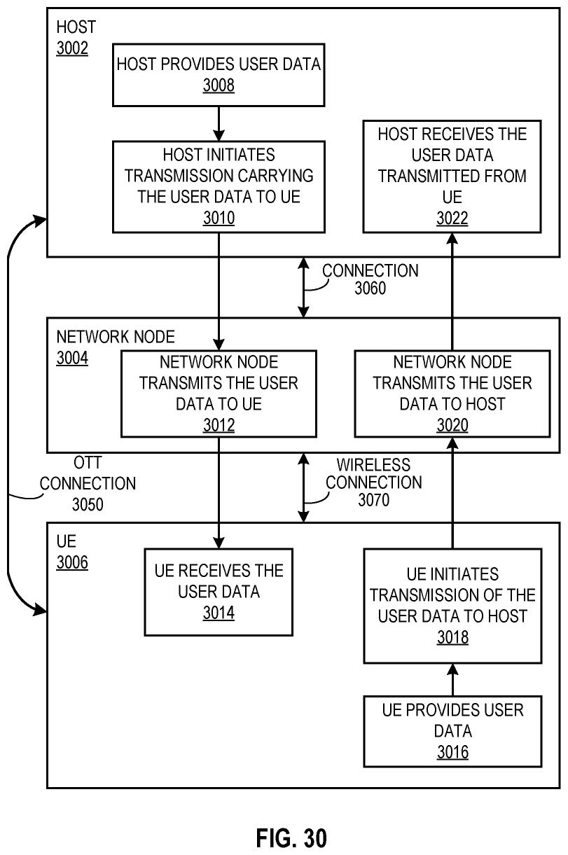

Hardware 2904 may be implemented in a standalone network node with generic or specific components. Hardware 2904 may implement some functions via virtualization. Alternatively, hardware 2904 may be part of a larger cluster of hardware (e.g. such as in a data center or CPE) where many hardware nodes work together and are managed via management and orchestration 2910, which, among others, oversees lifecycle management of applications 2902. In some embodiments, hardware 2904 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2912 which may alternatively be used for communication between hardware nodes and radio units. FIG. 30 shows a communication diagram of a host 3002 communicating via a network node 3004 with a UE 3006 over a partially wireless connection in accordance with some embodiments. Example implementations, in accordance with various embodiments, of the UE (such as a UE 2512a of FIG. 25 and/or UE 2600 of FIG. 26), network node (such as network node 2510a of FIG. 25 and/or network node 2700 of FIG. 27), and host (such as host 2516 of FIG. 25 and/or host 2800 of FIG. 28) discussed in the preceding paragraphs will now be described with reference to FIG. 30.

Like host 2800, embodiments of host 3002 include hardware, such as a communication interface, processing circuitry, and memory. The host 3002 also includes software, which is stored in or accessible by the host 3002 and executable by the processing circuitry. The software includes a host application that may be operable to provide a service to a remote user, such as the UE 3006 connecting via an over-the-top (OTT) connection 3050 extending between the UE 3006 and host 3002. In providing the service to the remote user, a host application may provide user data which is transmitted using the OTT connection 3050.

The network node 3004 includes hardware enabling it to communicate with the host 3002 and UE 3006. The connection 3060 may be direct or pass through a core network (like core network 2506 of FIG. 25) and/or one or more other intermediate networks, such as one or more public, private, or hosted networks. For example, an intermediate network may be a backbone network or the Internet.

The UE 3006 includes hardware and software, which is stored in or accessible by UE 3006 and executable by the UE's processing circuitry. The software includes a client application, such as a web browser or operator-specific “app” that may be operable to provide a service to a human or non-human user via UE 3006 with the support of the host 3002. In the host 3002, an executing host application may communicate with the executing client application via the OTT connection 3050 terminating at the UE 3006 and host 3002. In providing the service to the user, the UE's client application may receive request data from the host's host application and provide user data in response to the request data. The OTT connection 3050 may transfer both the request data and the user data. The UE's client application may interact with the user to generate the user data that it provides to the host application through the OTT connection 3050.

The OTT connection 3050 may extend via a connection 3060 between the host 3002 and the network node 3004 and via a wireless connection 3070 between the network node 3004 and the UE 3006 to provide the connection between the host 3002 and the UE 3006. The connection 3060 and wireless connection 3070, over which the OTT connection 3050 may be provided, have been drawn abstractly to illustrate the communication between the host 3002 and the UE 3006 via the network node 3004, without explicit reference to any intermediary devices and the precise routing of messages via these devices.

As an example of transmitting data via the OTT connection 3050, in step 3008, the host 3002 provides user data, which may be performed by executing a host application. In some embodiments, the user data is associated with a particular human user interacting with the UE 3006. In other embodiments, the user data is associated with a UE 3006 that shares data with the host 3002 without explicit human interaction. In step 3010, the host 3002 initiates a transmission carrying the user data towards the UE 3006. The host 3002 may initiate the transmission responsive to a request transmitted by the UE 3006. The request may be caused by human interaction with the UE 3006 or by operation of the client application executing on the UE 3006. The transmission may pass via the network node 3004, in accordance with the teachings of the embodiments described throughout this disclosure. Accordingly, in step 3012, the network node 3004 transmits to the UE 3006 the user data that was carried in the transmission that the host 3002 initiated, in accordance with the teachings of the embodiments described throughout this disclosure. In step 3014, the UE 3006 receives the user data carried in the transmission, which may be performed by a client application executed on the UE 3006 associated with the host application executed by the host 3002.

In some examples, the UE 3006 executes a client application which provides user data to the host 3002. The user data may be provided in reaction or response to the data received from the host 3002. Accordingly, in step 3016, the UE 3006 may provide user data, which may be performed by executing the client application. In providing the user data, the client application may further consider user input received from the user via an input/output interface of the UE 3006. Regardless of the specific manner in which the user data was provided, the UE 3006 initiates, in step 3018, transmission of the user data towards the host 3002 via the network node 3004. In step 3020, in accordance with the teachings of the embodiments described throughout this disclosure, the network node 3004 receives user data from the UE 3006 and initiates transmission of the received user data towards the host 3002. In step 3022, the host 3002 receives the user data carried in the transmission initiated by the UE 3006.

One or more of the various embodiments improve the performance of OTT services provided to the UE 3006 using the OTT connection 3050, in which the wireless connection 3070 forms the last segment.

In an example scenario, factory status information may be collected and analyzed by the host 3002. As another example, the host 3002 may process audio and video data which may have been retrieved from a UE for use in creating maps. As another example, the host 3002 may collect and analyze real-time data to assist in controlling vehicle congestion (e.g., controlling traffic lights). As another example, the host 3002 may store surveillance video uploaded by a UE. As another example, the host 3002 may store or control access to media content such as video, audio, VR or AR which it can broadcast, multicast or unicast to UEs. As other examples, the host 3002 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 3050 between the host 3002 and UE 3006, in response to variations in the measurement results. The measurement procedure and/or the network functionality for reconfiguring the OTT connection may be implemented in software and hardware of the host 3002 and/or UE 3006. In some embodiments, sensors (not shown) may be deployed in or in association with other devices through which the OTT connection 3050 passes; the sensors may participate in the measurement procedure by supplying values of the monitored quantities exemplified above, or supplying values of other physical quantities from which software may compute or estimate the monitored quantities. The reconfiguring of the OTT connection 3050 may include message format, retransmission settings, preferred routing etc.; the reconfiguring need not directly alter the operation of the network node 3004. Such procedures and functionalities may be known and practiced in the art. In certain embodiments, measurements may involve proprietary UE signaling that facilitates measurements of throughput, propagation times, latency and the like, by the host 3002. The measurements may be implemented in that software causes messages to be transmitted, in particular empty or ‘dummy’ messages, using the OTT connection 3050 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Notably, modifications and other embodiments of the present disclosure will come to mind to one skilled in the art having the benefit of the teachings presented in the foregoing descriptions and the associated drawings. Therefore, it is to be understood that the present disclosure is not to be limited to the specific embodiments disclosed and that modifications and other embodiments are intended to be included within the scope of this disclosure. Although specific terms may be employed herein, they are used in a generic and descriptive sense only and not for purposes of limitation.

### Embodiments

### Group A Embodiments

A1. A method performed by a proximity services anchor node, the method comprising:
receiving, from an authentication server, a proximity services relay user key associated with a remote wireless communication device;
deriving, from the proximity services relay user key, a shared key for protecting an interface between the remote wireless communication device and a relay wireless communication device configured to relay traffic for the remote wireless communication device; and
transmitting the shared key to a network node serving the relay wireless communication device.

A2. The method of embodiment A1, wherein the proximity services relay user key is based on and/or is specific to a certain run of a primary authentication procedure for primary authentication of the remote wireless communication device.

A3. The method of any of embodiments A1-A2, further comprising:
receiving, from the network node, a shared key request that requests the shared key from the proximity services anchor node;
after receiving the shared key request, transmitting, to the authentication server, a request for primary authentication of the remote wireless communication device; and
receiving, from the authentication server, a response to the request for primary authentication, wherein the response to the request for primary authentication includes the proximity services relay user key.

A4. The method of embodiment A3, wherein the shared key request includes a subscription identifier that identifies a subscription of the remote wireless communication device to a home network of the remote wireless communication device.

A5. The method of any of embodiments A3-A4, further comprising transmitting, to the network node, a response to the shared key request, wherein the response to the shared key request includes the shared key.

A6. The method of any of embodiments A1-A5, further comprising receiving, from the authentication server, an identifier bound to the proximity services relay user key.

A7. The method of embodiment A6, further comprising storing, in storage at the proximity services anchor node, the proximity services relay user key in association with the received identifier.

A8. The method of embodiment A7, further comprising:
receiving, from a requesting node, a fresh shared key request that indicates the identifier bound to the proximity services relay user key;
using the identifier indicated in the fresh shared key request, retrieving the proximity services relay user key from the storage at the proximity services anchor node;
deriving, from the retrieved proximity services relay user key, a fresh shared key for the remote wireless communication device; and
transmitting the fresh shared key to the requesting node in a response to the fresh shared key request.

A9. The method of any of embodiments A7-A8, further comprising storing the proximity services relay user key also in association with a subscription identifier that identifies a subscription of the remote wireless communication device to a home network of the remote wireless communication device.

A10. The method of any of embodiments A1-A9, further comprising receiving, from the authentication server, a subscription identifier that identifies a subscription of the remote wireless communication device to a home network of the remote wireless communication device.

A11. The method of any of embodiments A1-A10, wherein the proximity services relay user key is received from the authentication server in a request to register the proximity services relay user key with the proximity services anchor node.

A12. The method of embodiment A11, wherein the request to register the proximity services relay user key also includes an identifier bound to the proximity services relay user key and/or also includes a subscription identifier that identifies a subscription of the remote wireless communication device to a home network of the remote wireless communication device.

A13. The method of embodiment A12, further comprising storing, in storage at the proximity services anchor node, the proximity services relay user key in association with the received identifier.

A14. The method of embodiment A13, further comprising:
after receiving the request to register the proximity services relay user key, receiving, from the network node, a shared key request that indicates the identifier bound to the proximity services relay user key; and
using the identifier indicated in the shared key request, retrieving the proximity services relay user key from the storage at the proximity services anchor node;
wherein the shared key is derived from the proximity services relay user key as retrieved from the storage;
wherein transmitting the shared key to the network node comprises transmitting, to the network node, a response to the shared key request, wherein the response includes the shared key.

A15. The method of any of embodiments A1-A14, wherein the proximity services relay user key is a 5G Proximity Services Relay User Key, 5GPRUK.

A16. The method of any of embodiments A1-A15, wherein the shared key is a key K_{NR_ProSe}. A17. The method of any of embodiments A1-A16, wherein the authentication server implements an Authentication Server Function, AUSF.

A18. The method of any of embodiments A1-A17, wherein the network node implements an Access and Mobility Function, AMF.

A19. The method of any of embodiments A1-A18, wherein the interface is a PC5 interface.

A20. The method of any of embodiments A1-A19, wherein the relay wireless communication device is a Layer-3 UE-to-Network Relay.

### Group B Embodiments

B1. A method performed by an authentication server, the method comprising:
generating a proximity services relay user key associated with a remote wireless communication device; and
transmitting the proximity services relay user key to a proximity services anchor node.

B2. The method of embodiment B1, wherein the proximity services relay user key is based on and/or is specific to a certain run of a primary authentication procedure for primary authentication of the remote wireless communication device.

B3. The method of any of embodiments B1-B2, further comprising:
receiving, from the proximity services anchor node, a request for primary authentication of the remote wireless communication device; and
transmitting, to the proximity services anchor node, a response to the request for primary authentication, wherein the response to the request for primary authentication includes the proximity services relay user key.

B4. The method of embodiment B3, wherein the response also includes a subscription identifier that identifies a subscription of the remote wireless communication device to a home network of the remote wireless communication device.

B5. The method of any of embodiments B1-B4, further comprising transmitting, to the proximity services anchor node, an identifier bound to the proximity services relay user key.

B6. The method of any of embodiments B1-B5, further comprising transmitting, to the proximity services anchor node, a subscription identifier that identifies a subscription of the remote wireless communication device to a home network of the remote wireless communication device.

B7. The method of any of embodiments B1-B6, further comprising transmitting, to the proximity services anchor node, a request to register the proximity services relay user key with the proximity services anchor node, wherein the proximity services relay user key is included in the request to register the proximity services relay user key.

B8. The method of embodiment B7, wherein the request to register the proximity services relay user key also includes an identifier bound to the proximity services relay user key and/or also includes a subscription identifier that identifies a subscription of the remote wireless communication device to a home network of the remote wireless communication device.

B9. The method of any of embodiments B1-B8, wherein the proximity services relay user key is a 5G Proximity Services Relay User Key, 5GPRUK.

B10. The method of any of embodiments B1-B9, wherein the authentication server implements an Authentication Server Function, AUSF.

B11. The method of any of embodiments B1-B10, wherein the proximity services relay user key is a credential from which is derivable a shared key for protecting an interface between the remote wireless communication device and a relay wireless communication device, wherein the relay wireless communication device is configured to relay traffic for the remote wireless communication device.

B12. The method of embodiment B11, wherein the interface is a PC5 interface.

B13. The method of any of embodiments B11-B12, wherein the relay wireless communication device is a Layer-3 UE-to-Network Relay.

### Group C Embodiments

C1. A method performed by a network node serving a relay wireless communication device configured to relay traffic for a remote wireless communication device, the method comprising:
transmitting, to a proximity services anchor node, a request for a shared key for protecting an interface between the remote wireless communication device and the relay wireless communication device;
receiving the shared key from the proximity services anchor node in a response to the request; and
transmitting the shared key to the relay wireless communication device.

C2. The method of embodiment C2, wherein the shared key is derivable from a proximity services relay user key, wherein the proximity services relay user key is based on and/or is specific to a certain run of a primary authentication procedure for primary authentication of the remote wireless communication device.

C3. The method of any of embodiments C1-C2, wherein the shared key request includes an identifier bound to a proximity services relay user key, wherein the received shared key is derived from the proximity services relay user key.

C4. The method of any of embodiments C2-C3, wherein the proximity services relay user key is a 5G Proximity Services Relay User Key, 5GPRUK.

C5. The method of any of embodiments C1-C2, wherein the shared key request includes a subscription identifier that identifies a subscription of the remote wireless communication device to a home network of the remote wireless communication device.

C6. The method of any of embodiments C1-C5, wherein the shared key is a key K_{NR_ProSe}.

C7. The method of any of embodiments C1-C6, wherein the network node implements an Access and Mobility Function, AMF.

C8. The method of any of embodiments C1-C7, wherein the interface is a PC5 interface.

C9. The method of any of embodiments C1-C8, wherein the relay wireless communication device is a Layer-3 UE-to-Network Relay.

### Group D Embodiments

D1. A method performed by a remote wireless communication device, the method comprising:
transmitting, to a relay wireless communication device, a request for the relay wireless communication device to relay traffic for the remote wireless communication, wherein the request requests reuse of a proximity services relay user key already associated with the remote wireless communication device.

D2. The method of embodiment D1, wherein the request requests reuse of a proximity services relay user key from a previous run of a primary authentication procedure for primary authentication of the remote wireless communication device.

D3. The method of any of embodiments D1-D2, wherein the request includes a proximity services relay user key reuse flag that requests reuse of a proximity services relay user key already associated with the remote wireless communication device.

D4. The method of any of embodiments D1-D3, wherein the proximity services relay user key is based on and/or is specific to a certain run of a primary authentication procedure for primary authentication of the remote wireless communication device.

D5. The method of any of embodiments D1-D4, further comprising receiving, from the relay wireless communication device, a response to the request indicating that the proximity services relay user key is to be reused.

D6. The method of any of embodiments D1-D5, further comprising:
reusing the proximity services relay user key to generate a shared key for protecting an interface between the remote wireless communication device and the relay wireless communication device; and
protecting the interface using the shared key.

D7. The method of embodiment D6, wherein the shared key is a key K_{NR_ProSe}.

D8. The method of any of embodiments D6-D7, wherein the interface is a PC5 interface.
D9. The method of any of embodiments D1-D8, wherein the proximity services relay user key is a 5G Proximity Services Relay User Key, 5GPRUK.

D10. The method of any of embodiments D1-D9, wherein the relay wireless communication device is a Layer-3 UE-to-Network Relay.

### Group E Embodiments

E1. A method performed by a relay wireless communication device, the method comprising: receiving, from a remote wireless communication device, a request for the relay wireless communication device to relay traffic for the remote wireless communication, wherein the request requests reuse of a proximity services relay user key already associated with the remote wireless communication device.

E2. The method of embodiment E1, wherein the request requests reuse of a proximity services relay user key from a previous run of a primary authentication procedure for primary authentication of the remote wireless communication device.

E3. The method of any of embodiments E1-E2, wherein the request includes a proximity services relay user key reuse flag that requests reuse of a proximity services relay user key already associated with the remote wireless communication device.

E4. The method of any of embodiments E1-E3, wherein the proximity services relay user key is based on and/or is specific to a certain run of a primary authentication procedure for primary authentication of the remote wireless communication device.

E5. The method of any of embodiments E1-E4, further comprising transmitting, to the remote wireless communication device, a response to the request indicating that the proximity services relay user key is to be reused.

E6. The method of any of embodiments E1-E5, wherein the proximity services relay user key is a 5G Proximity Services Relay User Key, 5GPRUK.

E7. The method of any of embodiments E1-E6, wherein the relay wireless communication device is a Layer-3 UE-to-Network Relay.

E8. The method of any of embodiments E1-E7, further comprising transmitting, to a network node serving the relay wireless communication device, a request for a shared key for protecting an interface between the remote wireless communication device and the relay wireless communication device, wherein the request for the shared key requests reuse of the proximity services relay user key for deriving the shared key.

E9. The method of embodiment E8, wherein the request for the shared key includes a proximity services relay user key reuse flag that requests reuse of the proximity services relay user key.

E10. The method of any of embodiments E8-E9, further comprising receiving, from the network node, a response to the request for the shared key, wherein the response to the request for the shared key includes the shared key and indicates that the proximity services relay user key is to be reused for deriving the shared key.

EE1. A method performed by a relay wireless communication device, the method comprising:
transmitting, to a network node serving the relay wireless communication device, a request for a shared key for protecting an interface between a remote wireless communication device and the relay wireless communication device, wherein the relay wireless communication device is configured to relay traffic for the remote wireless communication device, wherein the request for the shared key requests reuse of a proximity services relay user key for deriving the shared key.

EE2. The method of embodiment EE1, wherein the request for the shared key includes a proximity services relay user key reuse flag that requests reuse of the proximity services relay user key.

EE3. The method of any of embodiments EE1-EE2, further comprising receiving, from the network node, a response to the request for the shared key, wherein the response to the request for the shared key includes the shared key and indicates that the proximity services relay user key is to be reused for deriving the shared key.

EE4. The method of any of embodiments EE1-EE3, wherein the request requests reuse of a proximity services relay user key from a previous run of a primary authentication procedure for primary authentication of the remote wireless communication device.

EE5. The method of any of embodiments EE1-EE4, wherein the proximity services relay user key is based on and/or is specific to a certain run of a primary authentication procedure for primary authentication of the remote wireless communication device.

EE6. The method of any of embodiments EE1-EE5, further comprising:
receiving, from the remote wireless communication device, a request for the relay wireless communication device to relay traffic for the remote wireless communication, wherein the request requests reuse of a proximity services relay user key already associated with the remote wireless communication device; and
transmitting, to the remote wireless communication device, a response to the request, wherein the response indicates that the proximity services relay user key is to be reused for deriving the shared key.

EE7. The method of any of embodiments EE1-EE6, wherein the proximity services relay user key is a 5G Proximity Services Relay User Key, 5GPRUK.

EE8. The method of any of embodiments EE1-EE7, wherein the relay wireless communication device is a Layer-3 UE-to-Network Relay.

EE9. The method of any of embodiments EE1-EE8, wherein the shared key is a key K_{NR_ProSe}.

EE10. The method of any of embodiments EE1-EE9, wherein the network node implements an Access and Mobility Function, AMF.

EE11. The method of any of embodiments EE1-EE10, wherein the interface is a PC5 interface.

### Group F Embodiments

F1. A method performed by a network node serving a relay wireless communication device, the method comprising:
receiving, from the relay wireless communication device, a request for a shared key for protecting an interface between a remote wireless communication device and the relay wireless communication device, wherein the relay wireless communication device is configured to relay traffic for the remote wireless communication device, wherein the request requests reuse of a proximity services relay user key for deriving the shared key.

F2. The method of embodiment F1, wherein the request requests reuse of a proximity services relay user key from a previous run of a primary authentication procedure for primary authentication of the remote wireless communication device.

F3. The method of any of embodiments F1-F2, wherein the request includes a proximity services relay user key reuse flag that requests reuse of a proximity services relay user key already associated with the remote wireless communication device.

F4. The method of any of embodiments F1-F3, wherein the proximity services relay user key is based on and/or is specific to a certain run of a primary authentication procedure for primary authentication of the remote wireless communication device.

F5. The method of any of embodiments F1-F4, further comprising transmitting, to the relay wireless communication device, a response to the request, wherein the response includes the shared key and indicates that the proximity services relay user key is to be reused for deriving the shared key.

F6. The method of any of embodiments F1-F5, wherein the proximity services relay user key is a 5G Proximity Services Relay User Key, 5GPRUK.

F7. The method of any of embodiments F1-F6, wherein the relay wireless communication device is a Layer-3 UE-to-Network Relay.

F8. The method of any of embodiments F1-F7, wherein the shared key is a key K_{NR_ProSe}.

F9. The method of any of embodiments F1-F8, wherein the network node implements an Access and Mobility Function, AMF.

F10. The method of any of embodiments F1-F9, wherein the interface is a PC5 interface.

FF1. A method performed by a network node serving a relay wireless communication device, the method comprising:
transmitting, to an authentication server, a request for authentication of the remote wireless communication device, wherein the request requests reuse of a proximity services relay user key for deriving a shared key for protecting an interface between the remote wireless communication device and the relay wireless communication device, wherein the relay wireless communication device is configured to relay traffic for the remote wireless communication device.

FF2. The method of embodiment FF1, wherein the request requests reuse of a proximity services relay user key from a previous run of a primary authentication procedure for primary authentication of the remote wireless communication device.

FF3. The method of any of embodiments FF1-FF2, wherein the request includes a proximity services relay user key reuse flag that requests reuse of a proximity services relay user key already associated with the remote wireless communication device.

FF4. The method of any of embodiments FF1-FF3, wherein the proximity services relay user key is based on and/or is specific to a certain run of a primary authentication procedure for primary authentication of the remote wireless communication device.

FF5. The method of any of embodiments FF1-FF4, further comprising receiving, from the authentication server, a response to the request, wherein the response includes the shared key and indicates that the proximity services relay user key is to be reused for deriving the shared key.

FF6. The method of any of embodiments FF1-FF5, wherein the proximity services relay user key is a 5G Proximity Services Relay User Key, 5GPRUK.

FF7. The method of any of embodiments FF1-FF6, wherein the relay wireless communication device is a Layer-3 UE-to-Network Relay.

FF8. The method of any of embodiments FF1-FF7, wherein the shared key is a key K_{NR_ProSe}. FF9. The method of any of embodiments FF1-FF8, wherein the network node implements an Access and Mobility Function, AMF.

FF10. The method of any of embodiments FF1-FF9, wherein the interface is a PC5 interface.

### Group G Embodiments

G1. A method performed by an authentication server, the method comprising:
receiving a request for authentication of a remote wireless communication device, wherein the request requests reuse of a proximity services relay user key for deriving a shared key for protecting an interface between the remote wireless communication device and a relay wireless communication device, wherein the relay wireless communication device is configured to relay traffic for the remote wireless communication device.

G2. The method of embodiment G1, wherein the request requests reuse of a proximity services relay user key from a previous run of a primary authentication procedure for primary authentication of the remote wireless communication device.

G3. The method of any of embodiments G1-G2, wherein the request includes a proximity services relay user key reuse flag that requests reuse of a proximity services relay user key already associated with the remote wireless communication device.

G4. The method of any of embodiments G1-G3, wherein the proximity services relay user key is based on and/or is specific to a certain run of a primary authentication procedure for primary authentication of the remote wireless communication device.

G5. The method of any of embodiments G1-G4, further comprising transmitting a response to the request, wherein the response includes the shared key and indicates that the proximity services relay user key is to be reused for deriving the shared key.

G6. The method of any of embodiments G1-G5, wherein the proximity services relay user key is a 5G Proximity Services Relay User Key, 5GPRUK.

G7. The method of any of embodiments G1-G6, wherein the relay wireless communication device is a Layer-3 UE-to-Network Relay.

G8. The method of any of embodiments G1-G7, wherein the shared key is a key K_{NR_ProSe}.

G9. The method of any of embodiments G1-G8, wherein the request is received from an Access and Mobility Function, AMF.

G10. The method of any of embodiments G1-G9, wherein the interface is a PC5 interface.

G11. The method of any of embodiments G1-G10, further comprising transmitting, to a data management node, a request for authentication credentials for the remote wireless communication device, wherein the request for authentication credentials requests reuse of the proximity services relay user key.

G12. The method of embodiment G11, further comprising receiving a response to the request for authentication credentials from the data management node, wherein the response indicates whether the proximity services relay user key is available for reuse.

G13. The method of embodiment G12, wherein the response indicates that the proximity services relay user key is available for reuse, and wherein the method further comprises: obtaining the shared key as derived from the proximity services relay user key; and transmitting a response to the request for authentication, wherein the response to the request for authentication includes the obtained shared key and indicates that the proximity services relay user key is to be reused for deriving the shared key.

G14. The method of embodiment G13, wherein obtaining the shared key comprises retrieving the proximity services relay user key from local storage at the authentication server and deriving the shared key from the retrieved proximity services relay user key.

G15. The method of embodiment G13, wherein obtaining the shared key comprises:
forwarding the request for authentication to another authentication server at which the proximity services relay user key is stored; and
receiving, from the another authentication server, the shared key as derived from the proximity services relay user key.

G16. The method of embodiment G12, wherein the response indicates that the proximity services relay user key is not available for reuse and includes the requested authentication credentials, and wherein the method further comprises:
generating a proximity services relay user key based on key material derived during authentication of the remote wireless communication device, wherein the authentication of the remote wireless communication device is based on the authentication credentials;
deriving the shared key from the generated proximity services relay user key; and
transmitting a response to the request for authentication, wherein the response to the request for authentication includes the derived shared key.

G17. The method of embodiment G16, wherein the response to the request for authentication indicates that the proximity services relay user key is not to be reused for deriving the shared key.

G18. The method of any of embodiments G16-G17, further comprising, after generating the proximity services relay user key, transmitting, to the data management node, signaling indicating that a proximity services relay user key for the remote wireless communication device is available for reuse and indicating the identity of the authentication server at which the proximity services relay user key is stored.

G19. The method of any of embodiments G1-G18, wherein the request is received from a network node serving the relay wireless communication device.

G20. The method of any of embodiments G1-G18, wherein the request is received from another authentication server.

GG1. A method performed by an authentication server, the method comprising:
transmitting, to a data management node, a request for authentication credentials for a remote wireless communication device, wherein the request for authentication credentials requests reuse of a proximity services relay user key for deriving a shared key for protecting an interface between the remote wireless communication device and a relay wireless communication device configured to relay traffic for the remote wireless communication device.

GG2. The method of embodiment GG1, further comprising receiving a response to the request for authentication credentials from the data management node, wherein the response indicates whether the proximity services relay user key is available for reuse.

GG3. The method of embodiment GG2, wherein the response indicates that the proximity services relay user key is available for reuse, and wherein the method further comprises:
obtaining the shared key as derived from the proximity services relay user key; and
transmitting, to a network node, a response to a request for authentication, wherein the response to the request for authentication includes the obtained shared key and indicates that the proximity services relay user key is to be reused for deriving the shared key.

GG4. The method of embodiment GG3, wherein obtaining the shared key comprises retrieving the proximity services relay user key from local storage at the authentication server and deriving the shared key from the retrieved proximity services relay user key.

GG5. The method of embodiment GG3, wherein obtaining the shared key comprises:
forwarding the request for authentication to another authentication server at which the proximity services relay user key is stored; and
receiving, from the another authentication server, the shared key as derived from the proximity services relay user key.

GG6. The method of embodiment GG2, wherein the response indicates that the proximity services relay user key is not available for reuse and includes the requested authentication credentials, and wherein the method further comprises:
generating a proximity services relay user key based on key material derived during authentication of the remote wireless communication device, wherein the authentication of the remote wireless communication device is based on the authentication credentials;
deriving the shared key from the generated proximity services relay user key; and
transmitting, to a network node, a response to a request for authentication, wherein the response to the request for authentication includes the derived shared key.

GG7. The method of embodiment GG6, wherein the response to the request for authentication indicates that the proximity services relay user key is not to be reused for deriving the shared key.

GG8. The method of any of embodiments GG1-GG7, wherein the proximity services relay user key is a 5G Proximity Services Relay User Key, 5GPRUK.

GG9. The method of any of embodiments GG1-GG8, wherein the relay wireless communication device is a Layer-3 UE-to-Network Relay.

GG10. The method of any of embodiments GG1-GG9, wherein the shared key is a key K_{NR_ProSe}.

GG11. The method of any of embodiments GG1-GG10, wherein the network node implements an Access and Mobility Function, AMF.

GG12. The method of any of embodiments GG1-GG11, wherein the interface is a PC5 interface.

### Group H Embodiments

H1. A method performed by a data management node, the method comprising:
receiving, from an authentication server, a request for authentication credentials for a remote wireless communication device, wherein the request for authentication credentials requests reuse of a proximity services relay user key for deriving a shared key that is to protect an interface between the remote wireless communication device and a relay wireless communication device configured to relay traffic for the remote wireless communication device.

H2. The method of embodiment H1, further comprising transmitting, to the authentication server, a response to the request, wherein the response indicates whether the proximity services relay user key is available for reuse.

H3. The method of embodiment H2, wherein the response indicates that the proximity services relay user key is available for reuse.

H4. The method of embodiment H3, wherein the response indicates an identity of an authentication server at which the proximity services relay user key is stored.

H5. The method of embodiment H2, wherein the response indicates that the proximity services relay user key is not available for reuse and includes the requested authentication credentials.

H6. The method of embodiment H5, further comprising, after transmitting the response:

receiving signaling indicating an identity of an authentication server at which a proximity services relay user key is stored; and

storing information at the data management node indicating that a proximity services relay user key for the remote wireless communication device is available for reuse and indicating the identity of the authentication server at which the proximity services relay user key is stored.

H7. The method of any of embodiments H1-H6, further comprising checking whether the proximity services relay user key is available for reuse, based on information at the data management node indicating whether any proximity services relay user key is stored for the remote wireless communication device.

H8. The method of any of embodiments H1-H7, wherein the proximity services relay user key is a 5G Proximity Services Relay User Key, 5GPRUK.

H9. The method of any of embodiments H1-H8, wherein the relay wireless communication device is a Layer-3 UE-to-Network Relay.

H10. The method of any of embodiments H1-H9, wherein the shared key is a key K_{NR_ProSe}.

H11. The method of any of embodiments H1-H10, wherein the interface is a PC5 interface.

### Group J Embodiments

J1. A proximity services anchor node configured to perform any of the steps of any of the Group A embodiments.

J2. A proximity services anchor node comprising processing circuitry configured to perform any of the steps of any of the Group A embodiments.

J3. A proximity services anchor node comprising:
communication circuitry; and
processing circuitry configured to perform any of the steps of any of the Group A embodiments.

J4. A proximity services anchor node comprising:
processing circuitry configured to perform any of the steps of any of the Group A embodiments; and
power supply circuitry configured to supply power to the proximity services anchor node.

J5. A proximity services anchor node comprising:
processing circuitry and memory, the memory containing instructions executable by the processing circuitry whereby the proximity services anchor node is configured to perform any of the steps of any of the Group A embodiments.

J6. A computer program comprising instructions which, when executed by at least one processor of a proximity services anchor node, causes the proximity services anchor node to carry out the steps of any of the Group A embodiments.

J7. A carrier containing the computer program of embodiment J6, wherein the carrier is one of an electronic signal, optical signal, radio signal, or computer readable storage medium.

J8. An authentication server configured to perform any of the steps of any of the Group B or Group G embodiments.

J9. An authentication server comprising processing circuitry configured to perform any of the steps of any of the Group B or Group G embodiments.

J10. An authentication server comprising:
communication circuitry; and
processing circuitry configured to perform any of the steps of any of the Group B or Group G embodiments.

J11. An authentication server comprising:
processing circuitry configured to perform any of the steps of any of the Group B or Group G embodiments; and
power supply circuitry configured to supply power to the authentication server.

J12. An authentication server comprising:
processing circuitry and memory, the memory containing instructions executable by the processing circuitry whereby the authentication server is configured to perform any of the steps of any of the Group B or Group G embodiments.

J13. A computer program comprising instructions which, when executed by at least one processor of an authentication server, causes the proximity services anchor node to carry out the steps of any of the Group B or Group G embodiments.

J14. A carrier containing the computer program of embodiment J13, wherein the carrier is one of an electronic signal, optical signal, radio signal, or computer readable storage medium.

J15. A network node configured to perform any of the steps of any of the Group C or Group F embodiments.

J16. A network node comprising processing circuitry configured to perform any of the steps of any of the Group C or Group F embodiments.

J17. A network node comprising:
communication circuitry; and
processing circuitry configured to perform any of the steps of any of the Group C or Group F embodiments.

J18. A network node comprising:
processing circuitry configured to perform any of the steps of any of the Group C or Group F embodiments;
power supply circuitry configured to supply power to the network node.

J19. A network node comprising:
processing circuitry and memory, the memory containing instructions executable by the processing circuitry whereby the network node is configured to perform any of the steps of any of the Group C or Group F embodiments.

J20. A computer program comprising instructions which, when executed by at least one processor of a network node, causes the network node to carry out the steps of any of the Group C or Group F embodiments.

J21. A carrier containing the computer program of embodiment J20, wherein the carrier is one of an electronic signal, optical signal, radio signal, or computer readable storage medium.

J22. A wireless communication device configured to perform any of the steps of any of the Group D or Group E embodiments.

J23. A wireless communication device comprising processing circuitry configured to perform any of the steps of any of the Group D or Group E embodiments.

J24. A wireless communication device comprising:
communication circuitry; and
processing circuitry configured to perform any of the steps of any of the Group D or Group E embodiments.

J25. A wireless communication device comprising:
processing circuitry configured to perform any of the steps of any of the Group D or Group E embodiments;
power supply circuitry configured to supply power to the wireless communication device.

J26. A wireless communication device comprising:
processing circuitry and memory, the memory containing instructions executable by the processing circuitry whereby the wireless communication device is configured to perform any of the steps of any of the Group D or Group E embodiments.

J27. A computer program comprising instructions which, when executed by at least one processor of a wireless communication device, causes the wireless communication device to carry out the steps of any of the Group D or Group E embodiments.

J28. A carrier containing the computer program of embodiment J27, wherein the carrier is one of an electronic signal, optical signal, radio signal, or computer readable storage medium.

J29. A user equipment (UE) comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group D or Group E embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

J30. A data management node configured to perform any of the steps of any of the Group H embodiments.

J31. A data management node comprising processing circuitry configured to perform any of the steps of any of the Group H embodiments.

J32. A data management node comprising:
communication circuitry; and
processing circuitry configured to perform any of the steps of any of the Group H embodiments.

J33. A data management node comprising:
processing circuitry configured to perform any of the steps of any of the Group H embodiments;
power supply circuitry configured to supply power to the data management node.

J34. A data management node comprising:
processing circuitry and memory, the memory containing instructions executable by the processing circuitry whereby the data management node is configured to perform any of the steps of any of the Group H embodiments.

J35. A computer program comprising instructions which, when executed by at least one processor of a data management node, causes the data management node to carry out the steps of any of the Group H embodiments.

J36. A carrier containing the computer program of embodiment J35, wherein the carrier is one of an electronic signal, optical signal, radio signal, or computer readable storage medium.

### Group K Embodiments

K9. A communication system including a host computer comprising:
processing circuitry configured to provide user data; and
a communication interface configured to forward user data to a cellular network for transmission to a user equipment (UE),
wherein the UE comprises a radio interface and processing circuitry, the UE's components configured to perform any of the steps of any of the Group D or Group E embodiments.

K10. The communication system of the previous embodiment, wherein the cellular network further includes a base station configured to communicate with the UE.

K11. The communication system of the previous 2 embodiments, wherein:
the processing circuitry of the host computer is configured to execute a host application, thereby providing the user data; and
the UE's processing circuitry is configured to execute a client application associated with the host application.

K12. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs any of the steps of any of the Group D or Group E embodiments.

K13. The method of the previous embodiment, further comprising at the UE, receiving the user data from the base station.

K14. A communication system including a host computer comprising:
communication interface configured to receive user data originating from a transmission from a user equipment (UE) to a base station,
wherein the UE comprises a radio interface and processing circuitry, the UE's processing circuitry configured to perform any of the steps of any of the Group D or Group E embodiments.

K15. The communication system of the previous embodiment, further including the UE.

K16. The communication system of the previous 2 embodiments, further including the base station, wherein the base station comprises a radio interface configured to communicate with the UE and a communication interface configured to forward to the host computer the user data carried by a transmission from the UE to the base station.

K17. The communication system of the previous 3 embodiments, wherein:
the processing circuitry of the host computer is configured to execute a host application; and
the UE's processing circuitry is configured to execute a client application associated with the host application, thereby providing the user data.

K18. The communication system of the previous 4 embodiments, wherein:
the processing circuitry of the host computer is configured to execute a host application, thereby providing request data; and
the UE's processing circuitry is configured to execute a client application associated with the host application, thereby providing the user data in response to the request data.

K19. A method implemented in a communication system including a host computer, a base station and a user equipment (UE), the method comprising:
at the host computer, receiving user data transmitted to the base station from the UE, wherein the UE performs any of the steps of any of the Group D or Group E embodiments.

K20. The method of the previous embodiment, further comprising, at the UE, providing the user data to the base station.

K21. The method of the previous 2 embodiments, further comprising:
at the UE, executing a client application, thereby providing the user data to be transmitted; and
at the host computer, executing a host application associated with the client application.

K22. The method of the previous 3 embodiments, further comprising:
at the UE, executing a client application; and
at the UE, receiving input data to the client application, the input data being provided at the host computer by executing a host application associated with the client application,
wherein the user data to be transmitted is provided by the client application in response to the input data.

K27. A method implemented in a communication system including a host computer, a base station and a user equipment (UE), the method comprising:
at the host computer, receiving, from the base station, user data originating from a transmission which the base station has received from the UE, wherein the UE performs any of the steps of any of the Group D or Group E embodiments.

K28. The method of the previous embodiment, further comprising at the base station, receiving the user data from the UE.

K29. The method of the previous 2 embodiments, further comprising at the base station, initiating a transmission of the received user data to the host computer.

1. A method performed by an authentication server, the method comprising:
receiving a request for authentication of a remote wireless communication device, wherein the request requests reuse of a proximity services relay user key for deriving a shared key for protecting an interface between the remote wireless communication device and a relay wireless communication device, wherein the relay wireless communication device is configured to relay traffic for the remote wireless communication device.

2. The method of claim 1, wherein the request requests reuse of a proximity services relay user key from a previous run of a primary authentication procedure for primary authentication of the remote wireless communication device.

3. The method of claim 1, wherein the request includes a proximity services relay user key reuse flag that requests reuse of a proximity services relay user key already associated with the remote wireless communication device.

4. The method of claim 1, wherein the proximity services relay user key is based on and/or is specific to a certain run of a primary authentication procedure for primary authentication of the remote wireless communication device.

5. The method of claim 1, further comprising transmitting a response to the request, wherein the response includes the shared key and indicates that the proximity services relay user key is to be reused for deriving the shared key.

6. The method of claim 1, wherein the proximity services relay user key is a 5G Proximity Services Relay User Key, 5GPRUK.

7. The method of claim 1, wherein the relay wireless communication device is a Layer-3 UE-to-Network Relay.

8. The method of claim 1, wherein the shared key is a key K_{NR_ProSe}.

9. The method of claim 1, wherein the request is received from an Access and Mobility Function, AMF.

10. The method of claim 1, wherein the interface is a PC5 interface.

11. The method of claim 1, further comprising transmitting, to a data management node, a request for authentication credentials for the remote wireless communication device, wherein the request for authentication credentials requests reuse of the proximity services relay user key.

12. The method of claim 11, further comprising receiving a response to the request for authentication credentials from the data management node, wherein the response indicates whether the proximity services relay user key is available for reuse.

13. The method of claim 12, wherein the response indicates that the proximity services relay user key is available for reuse, and wherein the method further comprises:
obtaining the shared key as derived from the proximity services relay user key; and
transmitting a response to the request for authentication, wherein the response to the request for authentication includes the obtained shared key and indicates that the proximity services relay user key is to be reused for deriving the shared key.

14. The method of claim 13, wherein obtaining the shared key comprises retrieving the proximity services relay user key from local storage at the authentication server and deriving the shared key from the retrieved proximity services relay user key.

15. The method of claim 13, wherein obtaining the shared key comprises:
forwarding the request for authentication to another authentication server at which the proximity services relay user key is stored; and
receiving, from the another authentication server, the shared key as derived from the proximity services relay user key.

16. The method of claim 12, wherein the response indicates that the proximity services relay user key is not available for reuse and includes the requested authentication credentials, and wherein the method further comprises:
generating a proximity services relay user key based on key material derived during authentication of the remote wireless communication device, wherein the authentication of the remote wireless communication device is based on the authentication credentials;
deriving the shared key from the generated proximity services relay user key; and
transmitting a response to the request for authentication, wherein the response to the request for authentication includes the derived shared key.

17-35. (canceled)

36. A method performed by a relay wireless communication device, the method comprising:
receiving, from a remote wireless communication device, a request for the relay wireless communication device to relay traffic for the remote wireless communication, wherein the request requests reuse of a proximity services relay user key already associated with the remote wireless communication device.

37. The method of claim 36, wherein the request requests reuse of a proximity services relay user key from a previous run of a primary authentication procedure for primary authentication of the remote wireless communication device.

38. The method of claim 36, wherein the request includes a proximity services relay user key reuse flag that requests reuse of a proximity services relay user key already associated with the remote wireless communication device.

39. The method of claim 36, wherein the proximity services relay user key is based on and/or is specific to a certain run of a primary authentication procedure for primary authentication of the remote wireless communication device.

40. The method of claim 36, further comprising transmitting, to the remote wireless communication device, a response to the request indicating that the proximity services relay user key is to be reused.

41. A method performed by a relay wireless communication device, the method comprising:
transmitting, to a network node serving the relay wireless communication device, a request for a shared key for protecting an interface between a remote wireless communication device and the relay wireless communication device, wherein the relay wireless communication device is configured to relay traffic for the remote wireless communication device, wherein the request for the shared key requests reuse of a proximity services relay user key for deriving the shared key.

42. The method of claim 41, wherein the request for the shared key includes a proximity services relay user key reuse flag that requests reuse of the proximity services relay user key.

43. The method of claim 41, further comprising receiving, from the network node, a response to the request for the shared key, wherein the response to the request for the shared key includes the shared key and indicates that the proximity services relay user key is to be reused for deriving the shared key.

44. The method of claim 41, wherein the request requests reuse of a proximity services relay user key from a previous run of a primary authentication procedure for primary authentication of the remote wireless communication device.

45. The method of claim 41, further comprising:
receiving, from the remote wireless communication device, a request for the relay wireless communication device to relay traffic for the remote wireless communication, wherein the request requests reuse of a proximity services relay user key already associated with the remote wireless communication device; and
transmitting, to the remote wireless communication device, a response to the request, wherein the response indicates that the proximity services relay user key is to be reused for deriving the shared key.

46-53. (canceled)

54. An authentication server comprising:
processing circuitry and memory, the memory containing instructions executable by the processing circuitry whereby the authentication server is configured to perform operations comprising:
receiving a request for authentication of a remote wireless communication device, wherein the request requests reuse of a proximity services relay user key for deriving a shared key for protecting an interface between the remote wireless communication device and a relay wireless communication device, wherein the relay wireless communication device is configured to relay traffic for the remote wireless communication device.

55. (canceled)

56. A relay wireless communication device comprising:
communication circuitry; and
processing circuitry configured to perform operations comprising:
receiving, from a remote wireless communication device, a request for the relay wireless communication device to relay traffic for the remote wireless communication, wherein the request requests reuse of a proximity services relay user key already associated with the remote wireless communication device.

57-62. (canceled)

63. The relay wireless communication device of claim 56, wherein the request requests reuse of a proximity services relay user key from a previous run of a primary authentication procedure for primary authentication of the remote wireless communication device.

64. The relay wireless communication device of claim 56, wherein the request includes a proximity services relay user key reuse flag that requests reuse of a proximity services relay user key already associated with the remote wireless communication device.

65. The relay wireless communication device of claim 56, wherein the proximity services relay user key is based on and/or is specific to a certain run of a primary authentication procedure for primary authentication of the remote wireless communication device.

66. The relay wireless communication device of claim 56, wherein the operations further comprise transmitting, to the remote wireless communication device, a response to the request indicating that the proximity services relay user key is to be reused.

67. The authentication server of claim 54, wherein the request requests reuse of a proximity services relay user key from a previous run of a primary authentication procedure for primary authentication of the remote wireless communication device.

68. The authentication server of claim 54, wherein the request includes a proximity services relay user key reuse flag that requests reuse of a proximity services relay user key already associated with the remote wireless communication device.

69. The authentication server of claim 54, wherein the proximity services relay user key is based on and/or is specific to a certain run of a primary authentication procedure for primary authentication of the remote wireless communication device.

70. The authentication server of claim 54, further comprising transmitting a response to the request, wherein the response includes the shared key and indicates that the proximity services relay user key is to be reused for deriving the shared key.
